(19) United States
(12) Patent Application Publication
(10) Pub. No.: US 2015/0149266 A1
(43) Pub. Date: May 28, 2015

(54) REWARD GRANTING SYSTEM, REWARD GRANTING METHOD, REWARD GRANTING DEVICE, REWARD GRANTING PROGRAM, REWARD-RELATED INFORMATION DISPLAY PROGRAM, AND REWARD-RELATED INFORMATION DISPLAY METHOD

(71) Applicant: Rakuten, Inc., Tokyo (JP)

(72) Inventors: Yoshitaka Inuzuka, Tokyo (JP); Narutaka Iwasaki, Tokyo (JP)

(73) Assignee: Rakuten, Inc., Tokyo (JP)

(21) Appl. No.: 14/404,394

(22) PCT Filed: Feb. 4, 2013
(86) PCT No.: PCT/JP2013/052489

§ 371 Date: Nov. 26, 2014

(30) Foreign Application Priority Data
May 31, 2012 (JP) 2012-124301

(51) Int. Cl. G06Q 30/02

(52) U.S. Cl. CPC G06Q 30/0212
USPC 705/14.14

(57) ABSTRACT

A reward granting device includes a determination unit that determines whether address information from a user terminal corresponds to reward address information, a reward-related information generation unit that generates reward-related information indicating that a website indicated by the address information is a website related to reward granting when it is determined that the address information corresponds to the reward address information, and a transmitting unit that transmits the reward-related information to the user terminal. A user of the user terminal can thereby recognize that the address information in an access request is relevant to reward granting, and therefore an access to the website by the user is encouraged, motivated by reward granting. Accordingly, the opportunities to view a specific website are increased.

### TECHNICAL FIELD

The present invention relates to a reward granting system, a reward granting method, a reward granting device, a reward granting program, a reward-related information display program, and a reward-related information display method.

### BACKGROUND ART

As the existing technique for encouraging a user to view a specific site on the Internet, there has been a technique that displays an object such as a banner advertisement to which a link to a specific site is set on a web page and then displays the specific site on a user terminal in response to selection of the banner advertisement (for example, see Patent Literature 1).

### CITATION LIST

### Patent Literature

PTL 1: Japanese Unexamined Patent Application Publication

### SUMMARY OF INVENTION

### Technical Problem

Because the website that is displayed in the above technique is only the specific site that is set as a link from the banner advertisement, another site related to the specific site is not likely to be viewed. On the other hand, an advertiser of the specific site desires to increase the opportunities that the specific site and a site related to the specific site are viewed by users.

In view of the foregoing, an object of the present invention is to provide a reward granting system, a reward granting method, a reward granting device, a reward granting program, a reward-related information display program, and a reward-related infolluation display method that can increase the opportunities that a specific website and a website related to the specific website on the Internet are viewed by users.

### Solution to Problem

To solve the above problem, a reward granting system according to one aspect of the present invention includes an address information extraction means configured to extract address information indicating a location of a website on the Internet and contained in an access request issued by a user terminal to access the website, an acquisition means configured to acquire the address information extracted by the address information extraction means, a determination means configured to determine whether the address information acquired by the acquisition means corresponds to reward address information by referring to a reward information storage means that stores reward address information being address information indicating a location of a website related to reward granting to a user of a user terminal in association with information about a description of a reward to be granted to a user, a generation means configured to generate reward-related information indicating that the website indicated by the address information is a website related to reward granting when it is determined by the determination means that the address information corresponds to the reward address information, a reward-related information acquisition means configured to acquire the reward-related information generated by the generation means in response to the address information extracted by the address information extraction means, and a display means configured to display the reward-related information acquired by the reward-related information acquisition means.

A reward granting method according to one aspect of the present invention includes an address information extraction step of extracting address information indicating a location of a website on the Internet and contained in an access request issued by a user terminal to access the website, an acquisition step of acquiring the address information extracted in the address information extraction step, a determination step of determining whether the address information acquired in the acquisition step corresponds to reward address information by referring to a reward information storage means that stores reward address information being address information indicating a location of a website related to reward granting to a user of a user terminal in association with information about a description of a reward to be granted to a user, a generation step of generating reward-related information indicating that the website indicated by the address information is a website related to reward granting when it is determined in the deteimination step that the address information corresponds to the reward address information, a reward-related information acquisition step of acquiring the reward-related information generated in the generation step in response to the address information extracted in the address information extraction step, and a display step of displaying the reward-related information acquired in the reward-related information acquisition step.

A reward granting device according to one aspect of the present invention is a reward granting device capable of communicating with a user terminal, including an acquisition means configured to acquire address information indicating a location of a website on the Internet and contained in an access request to the website from the user terminal, a determination means configured to determine whether the address information acquired by the acquisition means corresponds to reward address information by referring to a reward information storage means that stores reward address information being address information indicating a location of a website related to reward granting to a user of a user terminal in association with information about a description of a reward to be granted to a user, a generation means configured to generate reward-related information indicating that the website indicated by the address information is a website related to reward granting when it is determined by the determination means that the address information corresponds to the reward address information, and a transmitting means configured to transmit the reward-related information generated by the generation means to the user terminal.

A reward granting method according to one aspect of the present invention is a reward granting method in a reward granting device capable of communicating with a user terminal, the method including an acquisition step of acquiring address information indicating a location of a website on the Internet and contained in an access request to the website from the user terminal, a determination step of determining whether the address information acquired in the acquisition step corresponds to reward address information by referring to a reward information storage means that stores reward address information being address information indicating a location of a website related to reward granting to a user of a user terminal in association with information about a description of a reward to be granted to a user, a generation step of generating reward-related information indicating that the website indicated by the address information is a website related to reward granting when it is determined in the determination step that the address information corresponds to the reward address information, and a transmitting step of transmitting the reward-related information generated in the generation step to the user terminal.

A reward granting program according to one aspect of the present invention is a reward granting program causing a computer to function as a reward granting device capable of communicating with a user terminal, the program causing the computer to implement an acquisition function to acquire address information indicating a location of a website on the Internet and contained in an access request to the website from the user terminal, a determination function to determine whether the address information acquired by the acquisition function corresponds to reward address information by referring to a reward information storage means that stores reward address information being address information indicating a location of a website related to reward granting to a user of a user terminal in association with information about a description of a reward to be granted to a user, a generation function to generate reward-related information indicating that the website indicated by the address information is a website related to reward granting when it is determined by the determination function that the address information corresponds to the reward address information, and a transmitting function to transmit the reward-related information generated by the generation function to the user terminal.

A reward-related information display program according to one aspect of the present invention causes a computer to implement an address information extraction function to extract address information indicating a location of a website on the Internet and contained in an access request issued by a user terminal to access the website, an address information transmitting function to transmit the address information extracted by the address information extraction function to a reward granting device that generates reward-related information indicating that the address information is a website related to a reward when the website indicated by the address information is a website related to a reward to be granted to a user, a reward-related information acquisition function to acquire reward-related information transmitted from the reward granting device in response to the address information transmitted by the address information transmitting function, and a display function to display the reward-related information acquired by the reward-related information acquisition function.

A reward-related information display method according to one aspect of the present invention is a reward-related information display method in a user terminal, the method including an address information extraction step of extracting address information indicating a location of a website on the Internet and contained in an access request issued by a user terminal to access the website, an address information transmitting step of transmitting the address information extracted in the address information extraction step to a reward granting device that generates reward-related information indicating that the address information is a website related to a reward when the website indicated by the address information is a website related to a reward to be granted to a user, a reward-related information acquisition step of acquiring reward-related information transmitted from the reward granting device in response to the address information transmitted in the address information transmitting step, and a display step of displaying the reward-related information acquired in the reward-related information acquisition step.

According to the above-described aspects, when address information from a user terminal corresponds to reward address information, reward-related information indicating that a website indicated by the address information is a website related to reward granting is transmitted to the user terminal, and the reward-related information is displayed on the user terminal. A user of the user terminal can thereby recognize that the address information in an access request is related to reward granting, and therefore an access to the website by the user is encouraged, motivated by the granting of a reward. Accordingly, the opportunities to view a specific website are increased.

In the reward granting device according to another aspect, the determination means may carry out a lottery to win or lose based on a specified winning probability set in advance in order to determine whether or not to grant a reward to a user of the user terminal having transmitted the address information corresponding to the reward address information, and the generation means may generate the reward-related information containing a result of the lottery in the determination means.

According to the above aspect, because a result of the lottery is displayed on the user terminal and a reward is granted to a user based on a result of the lottery, it is possible to enhance the contrivance for accesses to the website. Accordingly, users' accesses to the website are further encouraged. Further, because a lottery process is carried out based on a specified winning probability, it is possible to appropriately control the source of funds related to reward granting.

In the reward granting device according to another aspect, the reward information storage means may store a plurality of ranks and a description of a reward for each of the ranks as the information about a description of a reward for each of the reward address information, and the determination means may carry out a lottery to win or lose on any rank of the plurality of ranks based on a specified winning probability set in advance for each of the ranks.

According to the above aspect, because a lottery is carried out for each of a plurality of ranks and a reward according to each rank is granted to a user, it is possible to further enhance the contrivance. Accordingly, users' accesses to the website are further encouraged.

In the reward granting device according to another aspect, in the reward information storage means, a reward address information group including a plurality of reward address information associated with one another may be set, reference ranks may be set for the plurality of reward address information included in the reward address information group, and the number of winners being the number of users to whom a reward is to be granted may be set for each of the reward address information, and the determination means may carry out a lottery by referring to the reward address information for which a highest reference rank is set among the reward address information where the number of users to whom a reward is granted does not reach the number of winners out of the plurality of reward address information included in the reward address information group as the valid reward address information.

According to the above aspect, the reward address information for which the highest reference rank is set out of the reward address information group is referred to in the lottery, and when the number of users to whom a reward is granted reaches the number of winners that is set for the reward address information, the reward address information for which the second highest reference rank is set is referred to. As a result, the valid reward address information transitions when a lottery is carried out by the determination means. Thus, even when information about one reward address information is leaked by one user to another user and that user makes an access request using the one reward address information, for example, the one reward address information is not necessarily valid at that point of time, and thereby transmission of reward-related information to that user is prevented.

In the reward granting device according to another aspect, the determination means may refer to a user attribute storage means that stores attribute information of a user and use a fact that a user of the user terminal has a specified attribute as a condition for the lottery.

According to the above aspect, the motivation of users to gain a specified attribute is enhanced. Further, the motivation of users having a specified attribute to access the website is enhanced.

The reward granting device according to another aspect may further include a matching degree determination means configured to determine a degree of matching of the address information acquired by the acquisition means with the reward address information stored in the reward information storage means, and a first hint information generation means configured to generate first hint information indicating the degree of matching determined by the matching degree determination means, and the transmitting means may transmit the first hint information generated by the first hint information generation means to the user terminal.

According to the above aspect, the hint information is transmitted to the user terminal, the degree of matching of the address information related to the access request with the reward address information is recognized by a user, and thereby the user's access to the website is encouraged, motivated by the granting of a reward.

The reward granting device according to another aspect may further include a link information receiving means configured to receive address information of a link contained in a webpage displayed on the user terminal, a link information determination means configured to determine whether the address information received by the link information receiving means corresponds to the reward address information stored in the reward information storage means, and a second hint information generation means configured to generate second hint information indicating that a link to the reward address information is contained in the webpage displayed on the user terminal when it is determined by the link information determination means that the address information corresponds to the reward address information, and the transmitting means may transmit the second hint information generated by the second hint information generation means to the user terminal.

According to the above aspect, a user of the user terminal can recognize that address information related to a link contained in the webpage displayed on the user terminal is relevant to reward granting, and thereby the user's access to the linked website is encouraged, motivated by the granting of a reward.

The reward granting device according to another aspect may further include a third hint information generation means configured to refer to a keyword storage means that stores keywords contained in a website indicated by the reward address information and generate third hint information containing one or more keywords, and the transmitting means may transmit the third hint information generated by the third hint information generation means to the user terminal.

According to the above aspect, because the hint info illation is transmitted to the user terminal, the keyword contained in the website indicated by the reward address information is recognized by a user. This recognition can be a motivation for searching the website by the keyword. Accordingly, the opportunities that the user views the website obtained as a result of the searching are increased.

The reward granting device according to another aspect may further include a specifying information determination means configured to acquire specifying information for specifying a website designated by a user from a specifying information storage means that stores the specifying information for each user or from the user terminal of the user, and determines whether the specifying information designated by the user corresponds to specifying information specifying a website indicated by the reward address information stored in the reward information storage means, and a fourth hint information generation means configured to generate fourth hint information indicating that the specifying information specifying the website indicated by the reward address information is included in the specifying information designated by the user when it is determined by the specifying information determination means that the specifying information designated by the user corresponds to the specifying information specifying the website indicated by the reward address information, and the transmitting means may transmit the fourth hint information generated by the fourth hint information generation means to the user terminal.

According to the above aspect, because the hint information is transmitted to the user terminal, it is recognized by a user that the specifying information designated by the user includes the one that specifies the website indicated by the reward address information. The user is thereby encouraged to access the website indicated by the specifying information.

In the reward granting device according to another aspect, the transmitting means may transmit the reward-related information together with instruction information for displaying the reward-related information superimposed on a webpage without altering source information for displaying the webpage on the user terminal.

In the reward-related information display program according to another aspect, the reward-related information receiving function may receive the reward-related information together with instruction information for displaying the reward-related information superimposed on a webpage without altering source information for displaying the webpage on the user terminal, and the display function may display the reward-related information superimposed on the webpage based on the instruction information received by the reward-related information receiving function.

According to the above aspect, because the reward-related information is displayed superimposed on the webpage, the reward-related information is recognized by the user of the user terminal. Further, because the reward-related information is not contained in the source information of the webpage, it is possible to prevent that the reward-related information is collected by a crawler which collects the contents of the webpage.

In the reward granting device according to another aspect, the transmitting means may transmit the reward-related information together with instruction information for displaying the reward-related information outside a display area of a webpage without altering source information for displaying the webpage on the user terminal.

In the reward-related information display program according to another aspect, the reward-related information receiving function may receive the reward-related information together with instruction information for displaying the reward-related information outside a display area of a webpage without altering source information for displaying the webpage on the user terminal, and the display function may display the reward-related information outside the display area of the webpage based on the instruction information received by the reward-related information receiving means.

According to the above aspect, because the reward-related information is displayed outside the display area of the webpage, the reward-related information is recognized by the user of the user terminal without degrading the visibility of the webpage. Further, because the reward-related information is not contained in the source information of the webpage, it is possible to prevent that the reward-related information is collected by a crawler which collects the contents of the webpage.

### Advantageous Effects of Invention

According to the present invention, it is possible to increase the opportunities that a specific website and a website related to the specific website on the Internet are viewed by users.

### BRIEF DESCRIPTION OF DRAWINGS

FIG. 1 is a diagram showing device components of a system including a reward granting device.

FIG. 2 is a block diagram showing a functional configuration of a reward granting device according to a first embodiment.

FIG. 3 is a diagram showing a hardware configuration of the reward granting device.

FIG. 4 is a block diagram showing a functional configuration of a user terminal according to the first embodiment.

FIGS. 5A and 5B are diagrams showing a configuration of a reward information storage unit and an example of data stored therein.

FIG. 6 is a diagram showing a configuration of a user attribute storage unit and an example of data stored therein.

FIG. 7 is a diagram showing a display example of a webpage displayed on the user terminal based on webpage information.

FIG. 8 is a diagram showing a display example of reward-related information.

FIG. 9 is a diagram showing a display example of reward-related information.

FIG. 11 is a timing chart showing a reward granting process performed in the reward granting device, the user terminal and the web server.

FIGS. 12A and 12B are diagrams showing a configuration of a reward granting program corresponding to the reward granting device according to the first embodiment.

FIG. 13 is a block diagram showing a functional configuration of a reward granting device according to a second embodiment.

FIG. 14 is a block diagram showing a functional configuration of a user terminal according to the second embodiment.

FIG. 15 is a diagram showing a display example of hint information.

FIG. 16 is a timing chart showing an example of a process for providing hint information to the user terminal.

FIG. 17 is a diagram showing a display example of hint information.

FIG. 18 is a timing chart showing an example of a process for providing hint information to the user terminal.

FIG. 19 is a diagram showing a configuration of a keyword storage unit and an example of data stored therein.

FIG. 20 is a diagram showing a display example of hint information.

FIG. 21 is a timing chart showing an example of a process for providing hint information to the user terminal.

FIG. 22 is a diagram showing a configuration of a bookmark storage unit and an example of data stored therein.

FIG. 23 is a diagram showing a display example of hint information.

FIG. 24 is a timing chart showing an example of a process for providing hint information to the user terminal.

### DESCRIPTION OF EMBODIMENTS

Embodiments of the present invention will be described hereinafter in detail with reference to the appended drawings. Note that, in the description of the drawings, the same or equivalent elements are denoted by the same reference symbols, and the redundant explanation thereof is omitted.

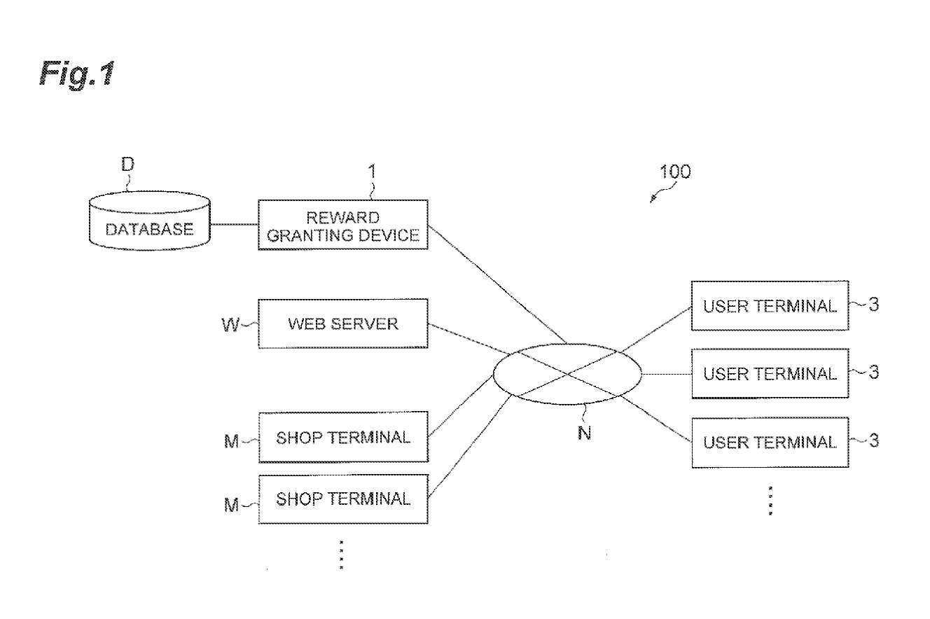

FIG. 1 is a block diagram showing device components of a system 100 (reward granting system) including a reward granting device according to this embodiment. The system 100 includes a reward granting device 1, a plurality of shop terminals M and a plurality of user terminals 3. The reward granting device 1 can access a database D that stores various data to be used for a process related to reward granting. Further, the system 100 includes a web server W. In response an access request to a website from the user terminal 3, the web server W transmits data for displaying a webpage on the user terminal 3.

The reward granting device 1, the web server W, the shop terminals M and the user terminals 3 can communicate with one another through a communication network N that is the Internet, a wireless LAN, a mobile communication network or the like. The reward granting device 1 is a server, for example. Further, the shop terminals M and the user terminals 3 are mobile terminals, personal computers and the like, for example. Note that, although two shop terminals M and three user terminals 3 are shown in FIG. 1, the number of terminals in the system 100 is arbitrary.

### First Embodiment

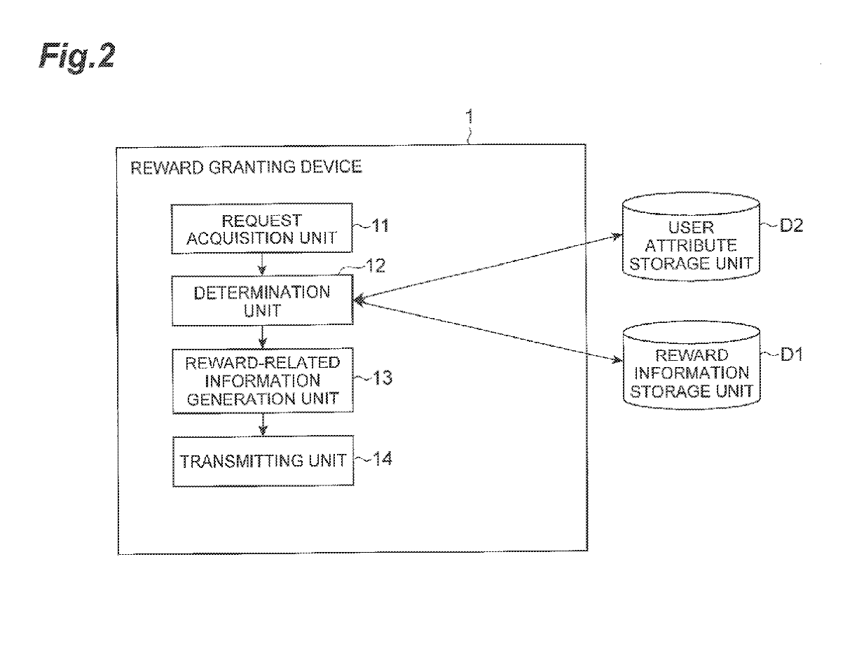

FIG. 2 is a block diagram showing a functional configuration of the reward granting device 1 according to a first embodiment. As shown in FIG. 2, the reward granting device 1 functionally includes a request acquisition unit 11 (acquisition means), a determination unit 12 (determination means), a reward-related information generation unit 13 (generation means), and a transmitting unit 14 (transmitting means). Further, the reward granting device 1 can access a reward information storage unit D1 (reward information storage means) and a user attribute storage unit D2 (user attribute storage means). Those storage units D1 and D2 are configured in the database D. Note that, although the functional units 11 to 14 are configured in one device in this embodiment, the functional units 11 to 14 may be included in different devices that can communicate with one another.

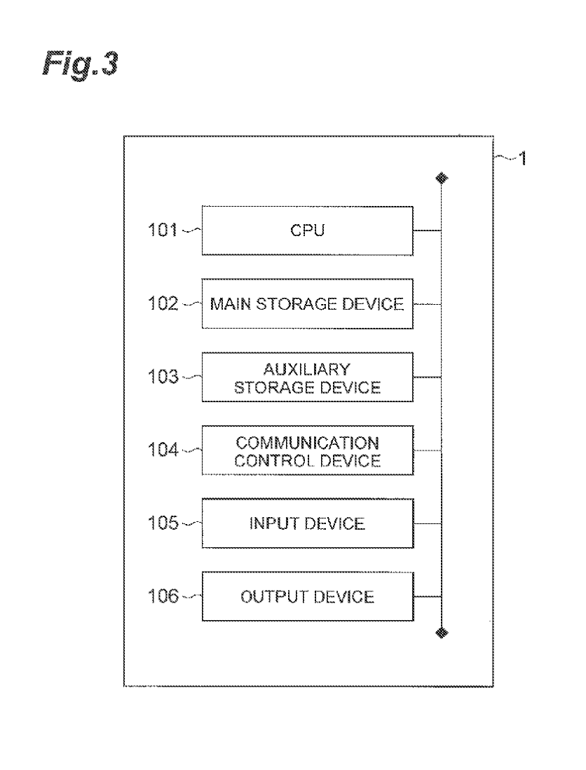

FIG. 3 is a hardware configuration diagram of the reward granting device 1. As shown in FIG. 3, the reward granting device 1 is physically configured as a computer system that includes a CPU 101, a main storage device 102 such as memory like RAM and ROM, an auxiliary storage device 103 such as a hard disk, a communication control device 104 such as a network card, an input device 105 such as a keyboard and a mouse, an output device 106 such as a display and the like.

The functions shown in FIG. 2 are implemented by loading given computer software (reward granting program) onto hardware such as the CPU 101 or the main storage device 102 shown in FIG. 3, making the communication control device 104, the input device 105 and the output device 106 operate under control of the CPU 101, and performing reading and writing of data in the main storage device 102 or the auxiliary storage device 103. Data and database required for the processing is stored in the main storage device 102 or the auxiliary storage device 103.

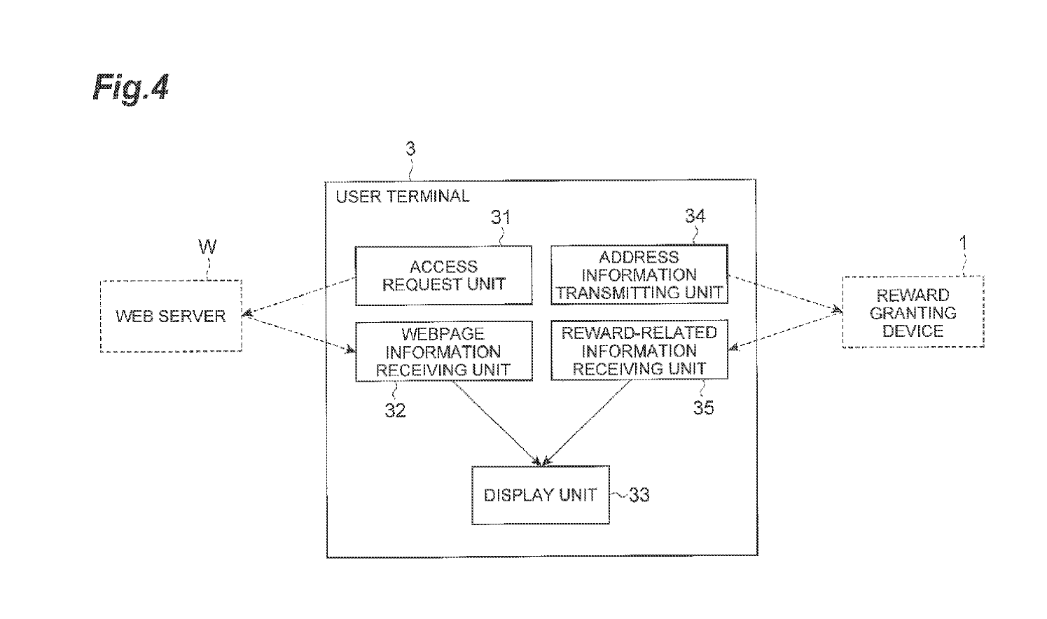

FIG. 4 is a block diagram showing a functional configuration of the user terminal 3. As shown in FIG. 4, the user terminal 3 functionally includes an access request unit 31, a webpage information receiving unit 32, a display unit 33 (display means), an address information transmitting unit 34 (address information extraction means, address information transmitting means), and a reward-related information receiving unit 35 (reward-related information receiving means, reward-related information acquisition means). The user terminal 3, like the reward granting device 1, is configured as a computer system and has a hardware configuration as shown in FIG. 3.

The functional units of the reward granting device 1 are described hereinafter with reference back to FIG. 2. The request acquisition unit 11 is a part that acquires address information that indicates the location of the website on the Internet and is contained in an access request to a website from the user terminal 3. The address information is information such as URL (Uniform Resource Locator), for example, indicating the location of the website on the Internet. The address information acquired by the request acquisition unit 11 is transmitted from the user terminal 3 to the reward granting device 1 when URL is entered or an object or text to which a link to URL is set is selected to access the website in a browser, a specified application or the like running on the user terminal 3.

The determination unit 12 is a part that determines whether the address information acquired by the request acquisition unit 11 corresponds to reward address information stored in the reward information storage unit D1 or not. The reward address information is address information indicating the location of a website related to reward granting to a user of the user terminal 3 and stored in the reward information storage unit D1 in association with information related to the description of a reward to be granted to a user.

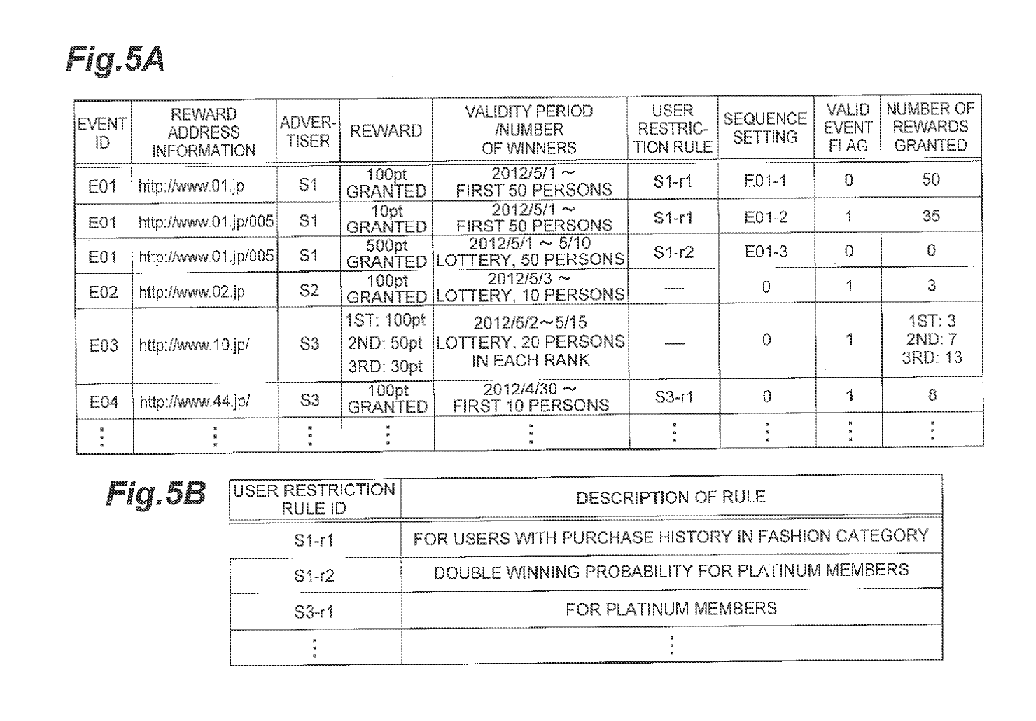

FIGS. 5A and 5B are diagrams showing a configuration of the reward information storage unit D1 and an example of data stored therein. As shown in FIG. 5A, the reward information storage unit D1 stores information such as reward address information, an advertiser, a reward, a validity period/the number of winners, a user restriction rule, a sequence setting, a valid event flag and the number of rewards granted as reward information for each event ID that identifies an event related to a reward to be granted to a user. Further, the description of the user restriction rule is stored in the table as shown in FIG. 5B, and the description of the rule is set for each user restriction rule ID. Each of the reward information is registered by an advertiser through the shop terminal M, for example. The advertiser is who wants the website indicated by the reward address information to be viewed by users.

The “reward” in FIG. 5A indicates the description of a reward, and points granted to a user are stored, for example. Note that, although the description of a reward is granting of points to a user in this embodiment, it may be giving of a free gift or the like to a user. Further, “the validity period/the number of winners” indicates the period when a reward is granted to users who access the reward address information and the number of users to whom a reward is granted.

The “user restriction rule” in FIG. 5A indicates ID of the rule that is referred to when a user to whom a reward is granted is restricted to a user having a specified attribute. The “sequence setting” is a field where a reference rank is set when the reward address information that is referred to in one event is transitioned. The “valid event flag” is a flag indicating the reward address information that should be currently referred to in the case where a reference rank is set in the “sequence setting”. The “number of rewards granted” indicates the number of users to whom a reward has been granted in the event.

A determination process in the determination unit 12 is specifically described hereinafter. The determination unit 12 determines whether the address information acquired by the request acquisition unit 11 corresponds to the reward address information of the event for which the valid event flag is set to “1” in the reward information storage unit D1. It may be determined that the address information corresponds to the reward address information on condition that the address information acquired by the request acquisition unit 11 totally matches the reward address information, or on condition that the address information acquired by the request acquisition unit 11 partly matches the reward address information. If partial matching is used as a condition for corresponding to the reward address information, even when user identification information, information of a site through which an access is made and the like are used as part of the address information indicating the same website, it is possible to determine that those address information correspond to the reward address information.

Further, in the case where it is set in the reward information storage unit D1 that a user to whom a reward is granted is determined by lottery, for example, the determination unit 12 carries out a lottery to win or lose based on a predetermined winning probability in order to determine whether or not to grant a reward to a user of the user terminal 3 that has transmitted the address information corresponding to the reward address information.

For example, when the address information acquired by the request acquisition unit 11 is “http://www.02.jp/”, the address information corresponds to the reward address information for the event ID “E02”, and because the granting of a reward by lottery is set, the determination unit 12 carries out a lottery based on a specified winning probability and determines whether or not to grant a reward to a user of the user terminal 3 that has transmitted to the address information. The determination unit 12 controls the event with the event ID “E02” to be valid until the number of users to whom a reward is granted reaches 10. Each time it is determined to grant a reward to a user, the determination unit 12 adds 1 to the value of the number of rewards granted that is associated with the event ID and update the reward information storage unit D1. Further, when the number of rewards granted reaches the number of winners, the determination unit 12 makes the valid event flag transition from 1 to 0 in the corresponding record. Note that the specified winning probability in a lottery may be set to a fixed value or may be set for each event in the reward information storage unit D1.

Because the granting of a reward to a user is determined by such a lottery process, it is possible to enhance the contrivance for accesses to the website. Accordingly, users' accesses to the website are encouraged. Further, because a lottery process is carried out based on a specified winning probability, it is possible to appropriately control the source of funds related to reward granting.

Further, in the case where a plurality of ranks and the description of a reward for each rank are set as information about a reward in the reward information storage unit D1, for example, the determination unit 12 can carry out a lottery to win or lose on any one of a plurality of ranks based on a specified winning probability that is preset for each rank. For example, when the address information acquired by the request acquisition unit 11 is “http://www.10.jp/”, the address information corresponds to the reward address information for the event ID “E03”, and because points granted for each of the first to third ranks are set as information of “reward”, the determination unit 12 carries out a lottery based on a winning probability that is set in advance for each rank and determines whether to grant points set for any rank to a user of the user terminal 3 that has transmitted to the address information or not to grant points to the user who loses in a lottery. By such a lottery process, it is possible to further enhance the contrivance. Accordingly, users' accesses to the website are further encouraged.

Further, in the case a reward address information group including a plurality of reward address information associated with one another is set, reference ranks are set for the plurality of reward address information included in the reward address information group, and the number of winners, which is the number of users to whom a reward is to be granted, is set for each reward address information, in the reward information storage unit D1, for example, the determination unit 12 carries out a lottery by referring to the reward address information for which the highest reference rank is set among the reward address information where the number of users to whom a reward is granted does not reach the number of winners out of the plurality of reward address information included in the reward address information group as the valid reward address information.

For example, in the reward information storage unit D1 shown in FIG. 5A, a reward address information group including three reward address information that are set in three records sharing the event ID “E01” is set, and further a reference rank such as “E01-1”, “E01-2” or “E01-3” is set for each record in the field of the sequence setting. In this case, at the start of the event ID “E01”, the determination unit 12 sets 1 to the valid event flag in the record of the highest reference rank “E01-1” and makes determination by reference to the reward address information “http://www.01.jp/” that is set in the record of the reference rank “E01-1”. Then, when the number of users to whom a reward is granted (the number of rewards granted) by an access to the reward address information and a lottery reaches “50” that is set in the field of “the number of winners”, the determination unit 12 makes the valid event flag in the record of the reference rank “EOM” from 1 to 0 and then makes the valid event flag in the record of the reference rank “E01-2” from 0 to 1 and carries out a lottery by referring to the reward address information “http://www.01.jp/” that is set in the record of the reference rank “E01-2” as the valid reward address infoxuiation. In the example shown in FIG. 5A, because the valid event flag “1” is set in the record of the reference rank “E01-2”, the determination unit 12 is currently referring to the reward address information “http://www.01.jp/”.

As a result of such a lottery process, the valid reward address information transitions when a lottery is carried out by the determination unit 12. Thus, even when information about one reward address information is leaked by one user to another user and that user makes an access request using the one reward address information, for example, the one reward address information is not necessarily valid at that point of time, and thereby transmission of reward-related information to that user is prevented.

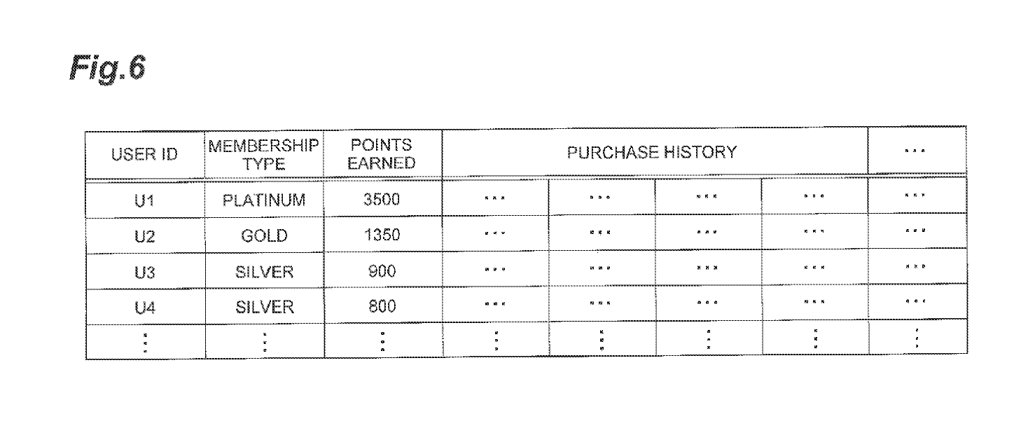

Further, the determination unit 12 can refer to the user attribute storage unit D2 that stores attribute information of users and use the fact that a user of the user terminal 3 has a specified attribute as a condition for a lottery. To be specific, the determination unit 12 can carry out a lottery to grant a reward to a user on condition that the user has a specified membership type, a specified purchase history or the like as the attribute information. FIG. 6 is a diagram showing a configuration of the user attribute storage unit D2 and an example of data stored therein. As shown in FIG. 6, the user attribute storage unit D2 stores information such as a membership type, points earned and a purchase history for each user ID.

To be specific, when the address information “http://www.44.jp/” from a user “U1” is acquired by the request acquisition unit 11, for example, because the address information corresponds to the reward address information for the event ID “E04” and “S3-r1” is set as the “user restriction rule”, the determination unit 12 refers to the description of the rule “for platinum members” that is associated with “S3-r1” from the table shown in FIG. 5B. Then, the determination unit 12 refers to the user attribute storage unit D2 shown in FIG. 6 and acquires the fact that the membership type of the user “U1” is “platinum” and therefore determines the user “U1” as a user to whom a reward is to be granted.

Carrying out such a lottery process enhances the motivation of users to gain a specified attribute and further enhances the motivation of users having a specified attribute to access the website.

The reward-related information generation unit 13 is a part that, when address information is determined to correspond to the reward address information by the determination unit 12, generates reward-related information indicating that the website indicated by the address information is a website related to reward granting. To be specific, the reward-related information generation unit 13 can generate information indicating the granting of a reward to a user and the description of the reward as the reward-related information. Further, when a lottery is carried out by the determination unit 12, the reward-related information generation unit 13 generates information indicating a result of a lottery, the granting of a reward to a user as a result of the lottery and the description of the reward as the reward-related information. Note that the details of the reward-related information and the way of display on the user terminal 3 are specifically described later.

The transmitting unit 14 is a part that transmits the reward-related information generated by the reward-related information generation unit 13 to the user terminal 3. Further, the transmitting unit 14 can transmit the reward-related information together with instruction information for displaying the reward-related information superimposed on the webpage without altering source information for displaying the webpage on the user terminal 3. Further, the transmitting unit 14 can transmit the reward-related information together with instruction information for displaying the reward-related information outside the display area of the webpage without altering source information for displaying the webpage on the user terminal 3. Because the reward-related information is thereby displayed on the user terminal 3, the reward-related information is recognized by the user of the user terminal 3. Further, because the reward-related information is not contained in the source information of the webpage, it is possible to prevent that the reward-related information is collected by a crawler which collects the contents of the webpage and that the location of the website related to reward granting is collected by the crawler. Note that the way of displaying the reward-related information based on the instruction information is illustrated in the description of the user terminal 3 provided later.

The functional units of the user terminal 3 are described hereinafter with reference back to FIG. 4. The access request unit 31 is a part that transmits an access request to the web server W to access a website. The access request contains address information such as URL, for example, indicating the location of the website on the Internet. When URL is entered or an object or text to which a link to URL is set is selected in a browser, a specified application or the like running on the user terminal 3, the access request unit 31 transmits an access request containing address information to the web server W.

The webpage information receiving unit 32 is a part that receives webpage information that is transmitted from the web server W in response to transmission of the access request. The webpage information is information for displaying the webpage on a browser, a specified application or the like running on the user terminal 3.

The display unit 33 is a part that displays a webpage based on the webpage information received by the webpage information receiving unit 32.

The address information transmitting unit 34 is a part that transmits address information contained in an access request to access the website to the reward granting device 1. The address information transmitting unit 34 can extract the address information from the access request transmitted by the access request unit 31 and transmit the extracted address information to the reward granting device 1.

The reward-related information receiving unit 35 is a part that receives reward-related information that is information transmitted from the transmitting unit 14 of the reward granting device 1 in response to the address information transmitted by the address information transmitting unit 34 and indicating that the website indicated by the address information is a website related to a reward to be granted to the user.

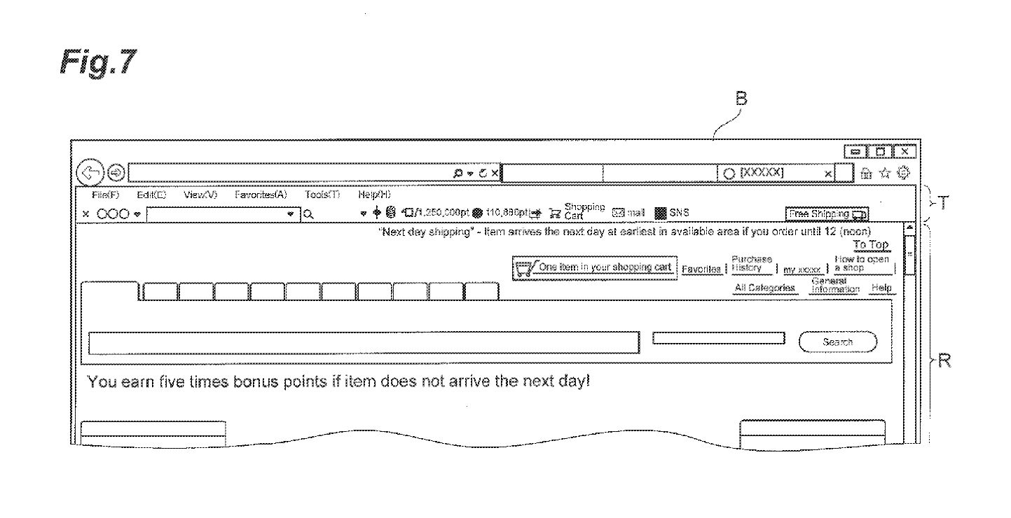

When the reward-related information is received by the reward-related information receiving unit 35, the display unit 33 displays the reward-related information. Hereinafter, examples of the webpage and the reward-related information displayed by the display unit 33 are described with reference to FIGS. 7 to 10.

FIG. 7 is a diagram showing a display example of a webpage displayed by the display unit 33 based on the webpage information received by the webpage information receiving unit 32. As shown in FIG. 7, a browser B includes a toolbar display area T and a webpage display area R, and the webpage is displayed in the webpage display area R.

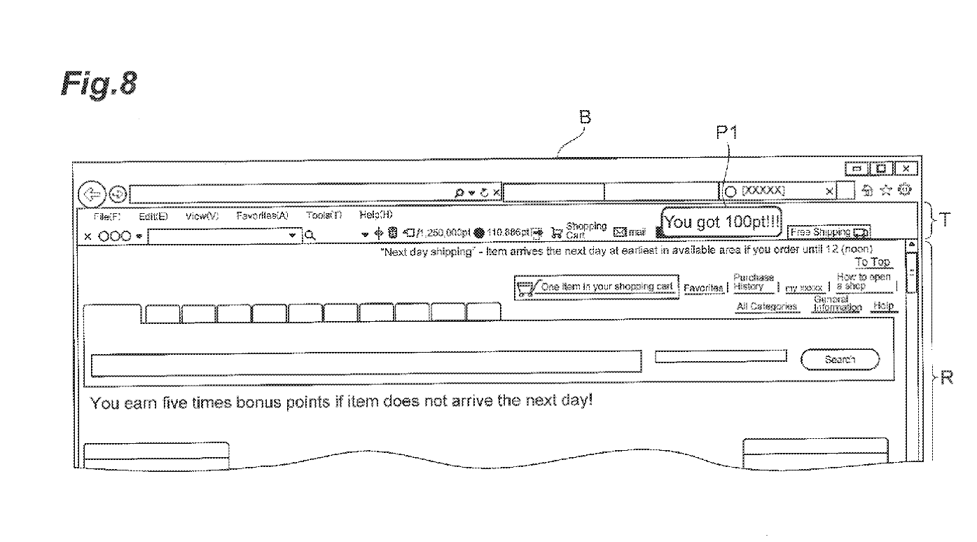

FIG. 8 is a diagram showing a display example of reward-related information. When the reward-related information is received together with the instruction information for displaying the reward-related information in the toolbar display area T outside the display area of the webpage without altering the source information for displaying the webpage on the user terminal 3 by the reward-related information receiving unit 35, the display unit 33 displays the reward-related information in the toolbar display area T based on the instruction information as shown in FIG. 8. Specifically, in the display example shown in FIG. 8, the webpage that is transmitted from the web server W in response to the access request is displayed in the webpage display area R and the reward-related information P1 indicating the description of a reward to a user such as “You got 100pt!!!” is displayed in the toolbar display area T.

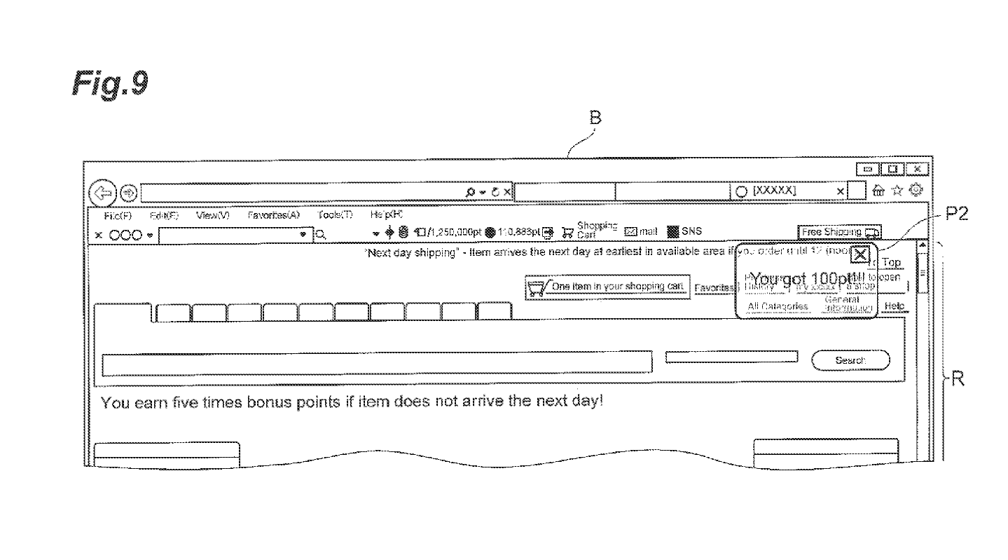

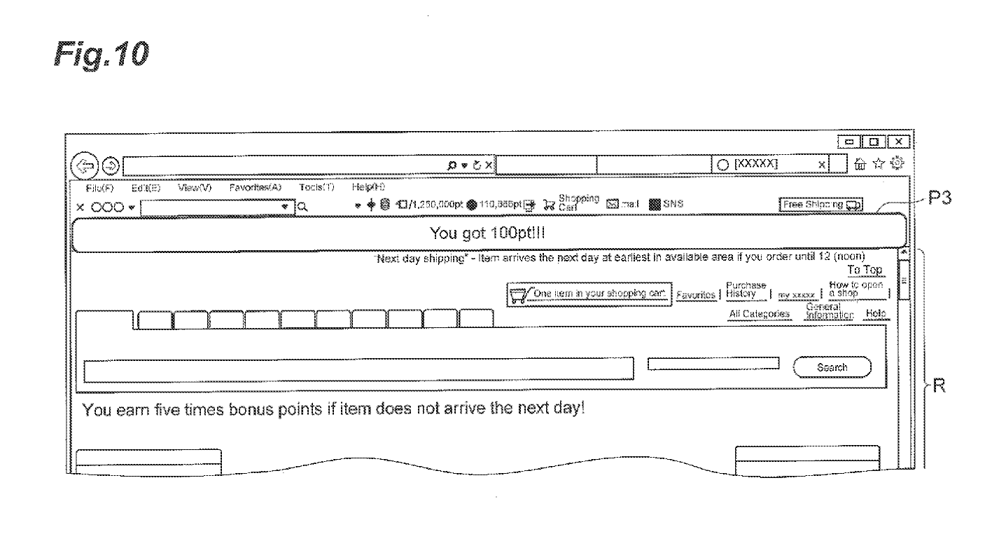

FIG. 9 is a diagram showing a display example of reward-related information. When the reward-related information is received together with the instruction information for displaying the reward-related information superimposed on the webpage without altering the source information for displaying the webpage on the user terminal 3 by the reward-related information receiving unit 35, the display unit 33 displays the reward-related information superimposed on the webpage displayed in the webpage display area R based on the instruction information as shown in FIG. 9. Specifically, in the display example shown in FIG. 9, the webpage that is transmitted from the web server W in response to the access request is displayed in the webpage display area R and the reward-related information P2 indicating the description of a reward to a user such as “You got 100pt!!!” is displayed superimposed on the webpage. Because the display of the reward-related information P2 is controlled independently of the display of the webpage, it can be erased by a user operation without affecting the display of the webpage.

FIG. 10 is a diagram showing a display example of the reward-related information. When the reward-related information is received together with the instruction information for moving the area where the webpage is displayed downward in the display area of the browser and displaying the reward-related information in the residual space produced by the movement without altering the source information for displaying the webpage on the user terminal 3 by the reward-related information receiving unit 35, the display unit 33 displays the reward-related information based on the instruction information as shown in FIG. 10. Specifically, in the display example shown in FIG. 10, the webpage that is transmitted from the web server W in response to the access request is displayed in the webpage display area R having a residual space in its upper part in the display area of the browser, and the reward-related information P3 indicating the description of a reward to a user such as “You got 100pt!!!” is displayed in the residual space produced in the display area of the browser.

Note that, the access request unit 31, the webpage information receiving unit 32 and the display unit 33 may be implemented as the functions of the browser running on the user terminal 3, and the address information transmitting unit 34 and the reward-related information receiving unit 35 may be implemented as the functions of the toolbar, for example. Further, the address information transmitting unit 34 and the reward-related information receiving unit 35 may be implemented as the add-in functions, for example, in the browser. Furthermore, the functional units 31 to 35 may be implemented as the functions of the application running on the user terminal 3.

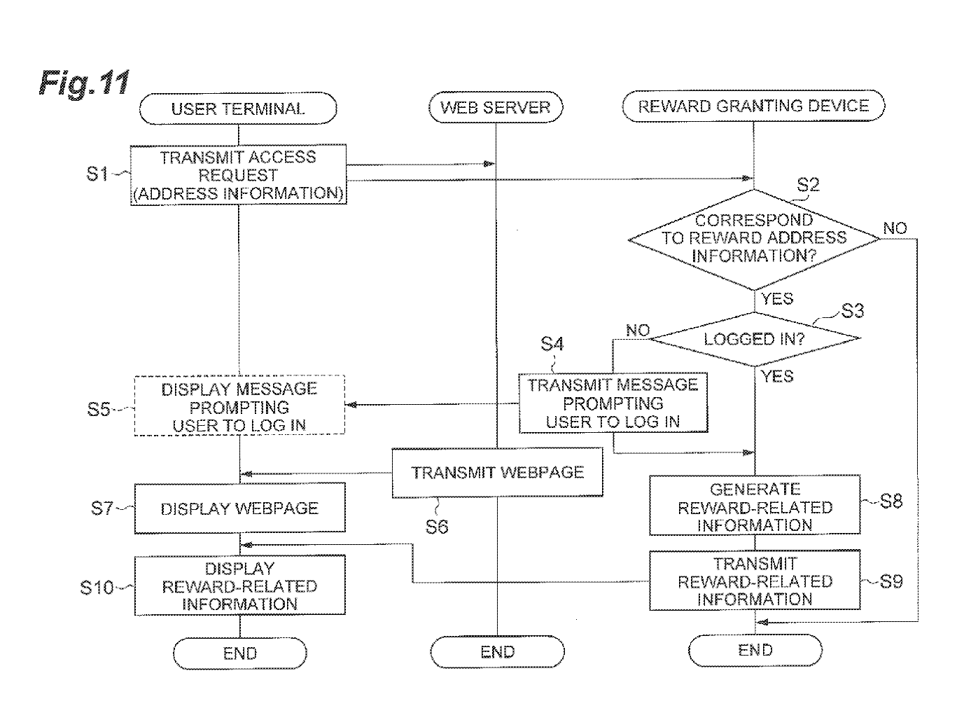

Hereinafter, the operation of the reward granting device 1 according to this embodiment is described with reference to FIG. 11. FIG. 11 is a timing chart showing a reward granting process that is performed in the reward granting device 1, the user terminal 3 and the web server W.

First, when URL is entered or an object or text to which a link to URL, is set is selected in a browser, a specified application or the like running on the user terminal 3, the access request unit 31 transmits an access request containing URL to the web server W (S1). Further, the address information transmitting unit 34 transmits the URL (address information) contained in the access request to the reward granting device 1 (S1).

When the URL is acquired by the request acquisition unit 11 of the reward granting device 1, the determination unit 12 determines whether the URL acquired by the request acquisition unit 11 corresponds to the reward address information stored in the reward information storage unit D1 (S2). At this time, the request acquisition unit 11 further acquires information about the login status of the user terminal 3 to the site related to reward granting like a shopping site, for example, from the user terminal 3. When the URL from the user terminal 3 corresponds to the reward address information, the process proceeds to Step S3. On the other and, when the URL from the user terminal 3 does not correspond to the reward address information, the process ends.

Then, in Step S3, the determination unit 12 determines whether the user terminal 3 has logged in based on the information about the login status of the user terminal 3 (S3). When the user terminal 3 has not logged in, the process proceeds to Step S4. On the other hand, when the user terminal 3 has logged in, the process proceeds to Step S8.

In Step S4, the transmitting unit 14 transmits a message that prompts a user to log in to the user terminal 3 (S4). To be specific, the transmitting unit 14 transmits a message indicating that the address information transmitted from the user terminal corresponds to the reward address information as the message that prompts a user to log in. Specifically, because it is determined in Step S4 that the address information from the user terminal corresponds to the reward address information, the transmitting unit 14 transmits a message such as “Log in and you can get a reward”, for example, to the user terminal 3. Note that, in the case where a reward associated with the reward address information is granted by a lottery, the transmitting unit 14 transmits a message indicating that a user can join a lottery for reward granting as the message that prompts a user to log in.

In response to the message transmitted from the reward granting device 1, the display unit 33 of the user terminal 3 displays the message that prompts a user to log in (S5). A user of the user terminal 3 is thereby encouraged to log into the system related to reward granting, motivated by the granting of a reward.

On the other hand, the web server W transmits webpage information for displaying the webpage in response to the access request from the user terminal 3 (S6). When the webpage information is received by the webpage information receiving unit 32 of the user terminal 3, the display unit 33 displays the webpage based on the webpage information (S7).

In Step S8, after a lottery process in the determination unit 12 according to need, the reward-related information generation unit 13 generates reward-related information that is related to the description of a reward (58). Then, the reward-related information generated by the reward-related information generation unit 13 is transmitted to the user terminal 3 (S9). When the reward-related information is received by the reward-related information receiving unit 35 of the user terminal 3, the display unit 33 displays the reward-related information (S10).

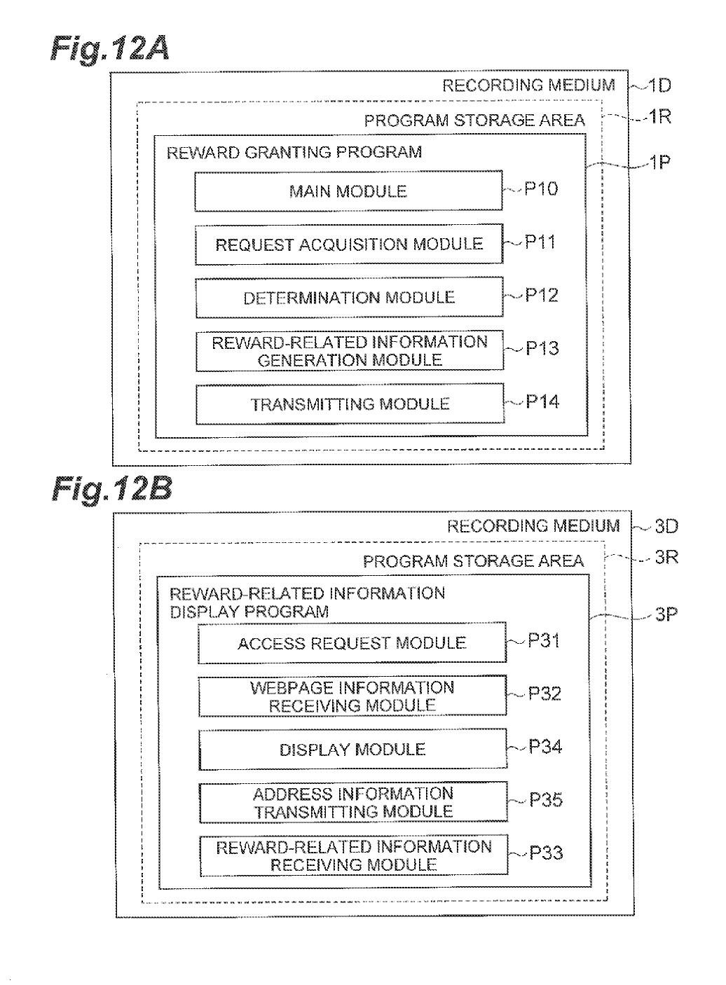

A reward granting program that causes a computer to function as the reward granting device 1 and a reward-related information display program in the user terminal 3 are described hereinafter with reference to FIGS. 12A and 12B. FIG. 12A is a diagram showing a reward granting program corresponding to the reward granting device 1 according to the first embodiment shown in FIG. 2.

A reward granting program 1P includes a main module P10, a request acquisition module P11, a determination module P12, a reward-related information generation module P13, and a transmitting module P14.

The main module P10 is a part that exercises control over the reward granting device 1. The functions implemented by executing the request acquisition module P11, the determination module P12, the reward-related information generation module P13 and the transmitting module P14 are respectively equal to the functions of the request acquisition unit 11, the determination unit 12, the reward-related information generation unit 13 and the transmitting unit 14 of the reward granting device 1 shown in FIG. 2.

The reward granting program 1P is provided through a storage medium 1D such as CD-ROM or DVD-ROM or semiconductor memory, for example. Further, the reward granting program 1P may be provided as a computer data signal superimposed onto a carrier wave over a communication network.

FIG. 12B is a diagram showing a configuration of a reward granting program 3P corresponding to the user terminal 3 according to the first embodiment shown in FIG. 4. The reward granting program 3P includes an access request module P31, a webpage information receiving module P32, a display module P33, an address information transmitting module P34, and a reward-related information receiving module P35. The functions implemented by executing the access request module P31, the webpage information receiving module P32, the display module P33, the address information transmitting module P34 and the reward-related information receiving module P35 are respectively equal to the functions of the access request unit 31, the webpage information receiving unit 32, the display unit 33, the address information transmitting unit 34 and the reward-related information receiving unit 35 shown in FIG. 4. Specifically, the access request unit 31, the webpage information receiving unit 32, the display unit 33, the address information transmitting unit 34 and the reward-related information receiving unit 35 of the user terminal 3 are implemented when the reward-related information display program 3P composed of the access request module P31, the webpage information receiving module P32, the display module P33, the address information transmitting module P34 and the reward-related information receiving module P35 is executed by a computer serving as the user terminal 3.

The reward-related information display program 3P is provided through a storage medium 1D such as CD-ROM or DVD-ROM or semiconductor memory, for example. Further, the reward-related information display program 3P may be provided as a computer data signal superimposed onto a carrier wave over a communication network. Note that, in the reward-related information display program 3P, the access request module P31, the webpage information receiving module P32 and the display module P33 are not essential elements.

According to the reward granting device 1, the reward granting method, the reward granting program 1P, the user terminal 3 and the reward-related information display program according to the first embodiment described above, when address information from the user terminal 3 corresponds to reward address information, reward-related information indicating that a website indicated by the address information is a website related to reward granting is transmitted to the user terminal, and the reward-related information is displayed on the user terminal. A user of the user terminal 3 can thereby recognize that the address information related to an access request is related to reward granting, and therefore an access to the website by the user is encouraged, motivated by the granting of a reward. Accordingly, the opportunities to view a specific website are increased.

### Second Embodiment

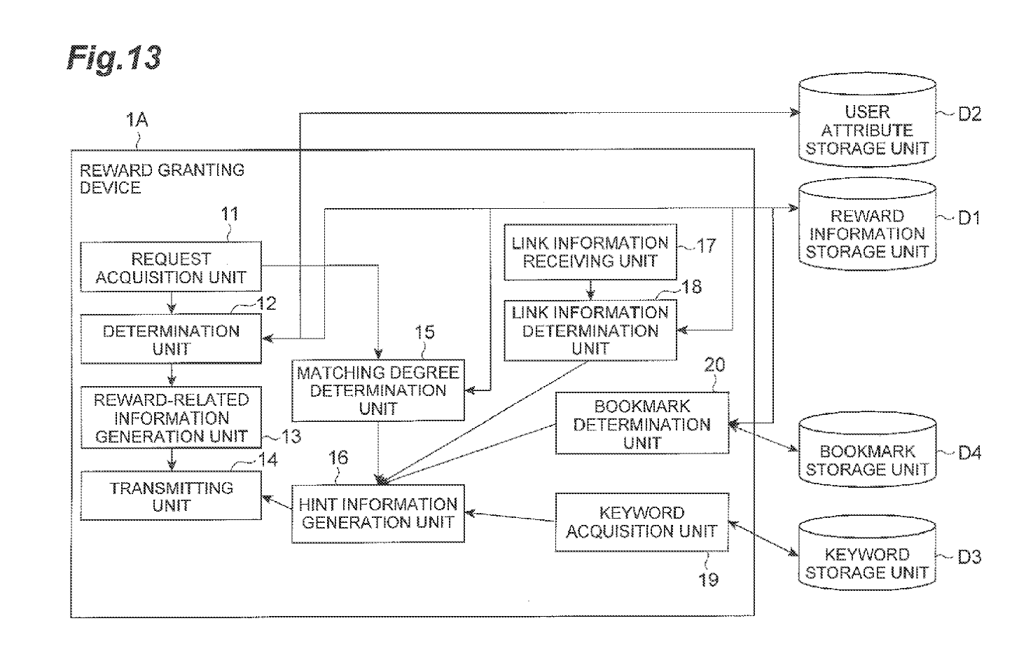

A second embodiment of a reward granting device according to a second embodiment is described hereinafter with reference to FIGS. 13 to 24. Note that, in FIGS. 13 to 24, the elements that are the same as or equal to the elements in the first embodiment are denoted by the same reference symbols and redundant description thereof is omitted.

In the second embodiment, hint information is provided to a user terminal 3A in order to increase the possibility that a user can access the website indicated by the reward address information.

FIG. 13 is a block diagram showing a functional configuration of a reward granting device 1A according to a second embodiment. As shown in FIG. 13, the reward granting device 1A includes a matching degree determination unit 15 (matching degree determination means), a hint information generation unit 16 (first hint information generation means, second hint information generation means, third hint information generation means, fourth hint information generation means), a link information receiving unit 17 (link information receiving means), a link information determination unit 18 (link information determination means), a keyword acquisition unit 19, and a bookmark determination unit 20 (specifying information determination means), in addition to the functional units 11 to 14 described with reference to FIG. 2. Further, the reward granting device 1A can access a keyword storage unit D3 (keyword storage means) and a bookmark storage unit D4 (specifying information storage means). Those storage units D3 and D4 are configured in the database D, for example.

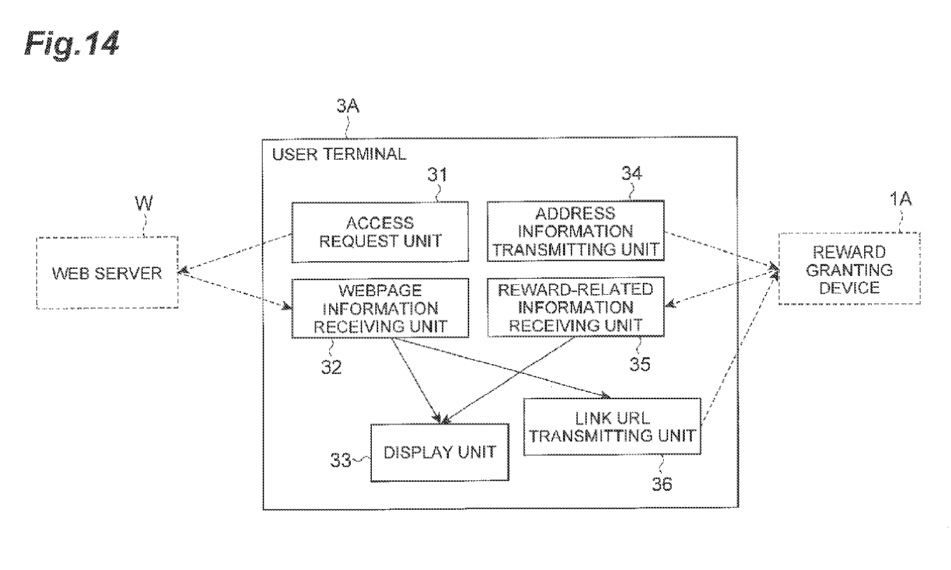

FIG. 14 is a block diagram showing a functional configuration of a user terminal 3A according to the second embodiment. The user terminal 3A includes a link URL transmitting unit 36 in addition to the functional units 31 to 35 described with reference to FIG. 4. Note that the functional units in the reward granting device 1A and the user terminal 3A are implemented when program modules for implementing the respective functions are executed by computers serving as the reward granting device 1A and the user terminal 3A. The programs composed of those program modules may be provided through a storage medium such as CD-ROM or DVD-ROM or semiconductor memory, for example. Further, the programs may be provided as a computer data signal superimposed onto a carrier wave over a communication network.

A process related to generation of hint information according to the second embodiment is described hereinafter with reference to FIGS. 13 and 14. First, provision of hint information based on the degree of similarity between address information contained in an access request and reward address information is described hereinbelow.

The matching degree determination unit 15 is a part that determines the degree of matching of the address information acquired by the request acquisition unit 11 with the reward address information stored in the reward information storage unit D1. To be specific, the matching degree determination unit 15 calculates the percentage of matching between the character string that constitutes the acquired address information and the character string that constitutes the reward address information, for example. Further, the matching degree determination unit 15 can previously store similar address information that is similar to the reward address information, and can determine that the acquired address information is similar to the reward address information when the acquired address information matches the similar address information.

The hint information generation unit 16 generates hint information (first hint information) indicating the degree of matching determined by the matching degree determination unit 15. To be specific, when the percentage of matching calculated by the matching degree determination unit 15 is a specified value or more, for example, the hint information generation unit 16 generates hint information such as a message “You may find a reward page nearby!!”, for example, based on the fact that the address information acquired by the request acquisition unit 11 is similar to the reward address information. Further, the hint information generation unit 16 can include information indicating the degree of matching between the address information acquired by the request acquisition unit 11 and the reward address information into the hint information. Then, the transmitting unit 14 transmits the hint information generated by the hint information generation unit 16 to the user terminal 3A.

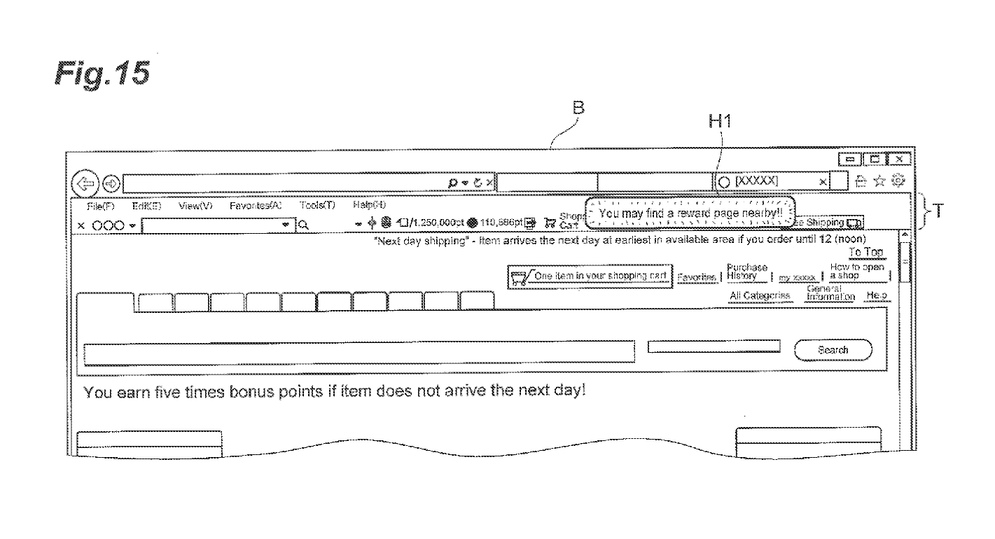

The reward-related information receiving unit 35 of the user terminal 3A receives the hint information transmitted from the reward granting device 1A as the reward-related information. Then, the display unit 33 displays the hint information received by the reward-related information receiving unit 35. FIG. 15 is a diagram showing a display example of the hint information. As shown in FIG. 15, the display unit 33 displays hint information H1 such as a message “You may find a reward page nearby!!” in the toolbar display area T, for example. At this time, the display unit 33 may control the display of the hint information H1 so that it turns on and off at a time interval according to the degree of matching between the address information acquired by the request acquisition unit 11 and the reward address information.

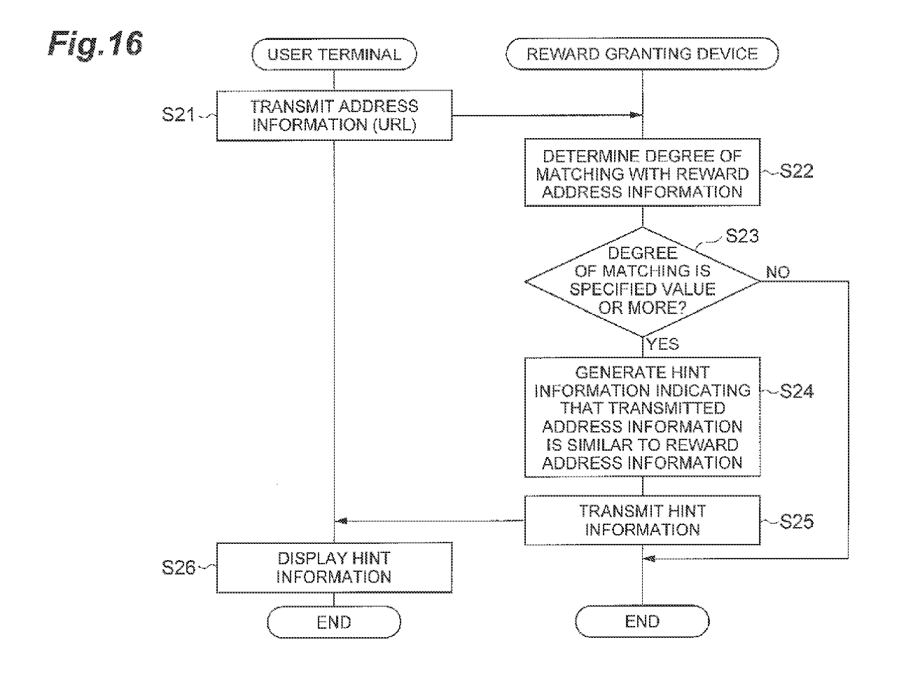

FIG. 16 is a timing chart showing an example of a process for providing the hint information H1 to the user terminal 3A. The address information transmitting unit 34 of the user terminal 3A transmits the address information contained in the access request to the reward granting device 1A (S21). Next, the matching degree determination unit 15 determines the degree of matching of the address information acquired by the request acquisition unit 11 with the reward address information (S22).

In Step S23, when the reward address information whose degree of matching with the address information acquired by the request acquisition unit 11 is equal to or higher than a specified value is stored in the reward information storage unit D1, the process proceeds to Step S24. On the other hand, when the reward address information whose degree of matching with the address information acquired by the request acquisition unit 11 is equal to or higher than a specified value is not stored in the reward information storage unit D1, the process ends.

In Step S24, the hint information generation unit 16 generates hint information indicating that the address information acquired by the request acquisition unit 11 is similar to the reward address information (S24). In the following Step S25, the transmitting unit 14 transmits the hint information generated by the hint information generation unit 16 to the user terminal 3A (S25). Then, the hint information is received by the reward-related information receiving unit 35 of the user terminal 3A, and the display unit 33 displays the hint information (S26).

As a result that the hint information is provided to the user terminal 3A as described above, the degree of matching of the address information related to the access request with the reward address information is recognized by a user, and thereby the user's access to the website is encouraged, motivated by the granting of a reward.

Provision of hint information based on a link in a webpage displayed on the user terminal 3A is described hereinafter with reference back to FIGS. 13 and 14.

The link URL transmitting unit 36 extracts address information (URL) that is set to one or more links contained in a webpage displayed on the user terminal 3A and transmits it to the reward granting device 1A. To be specific, the link URL transmitting unit 36 can extract the URL by searching webpage information such as HTML received by the webpage information receiving unit 32. The link URL transmitting unit 36 can thereby extract the URL that is set to a link contained in a result of search conducted in a given search site. Then, the link information receiving unit 17 of the reward granting device 1A receives the address information from the link URL transmitting unit 36.

The link information determination unit 18 determines whether the address information received by the link information receiving unit 17 corresponds to the reward address information stored in the reward information storage unit D1. Then, when the link information determination unit 18 determines that the address information that is set to the link corresponds to the reward address information, the hint information generation unit 16 generates hint information (second hint information) indicating that a link to the reward address information is contained in the webpage displayed on the user terminal 3A. The transmitting unit 14 transmits the hint information generated by the hint information generation unit 16 to the user terminal 3A.

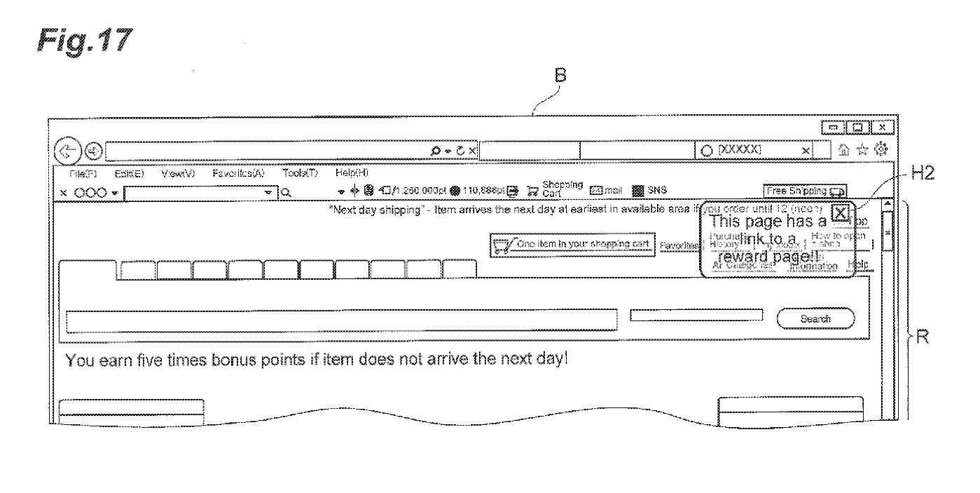

The reward-related information receiving unit 35 of the user terminal 3A receives the hint information transmitted from the reward granting device 1A as the reward-related information. Then, the display unit 33 displays the hint information received by the reward-related information receiving unit 35. FIG. 17 is a diagram showing a display example of the hint information. As shown in FIG. 17, the display unit 33 displays hint information H2 such as a message “This page has a link to a reward page!!” superimposed on the webpage, for example.

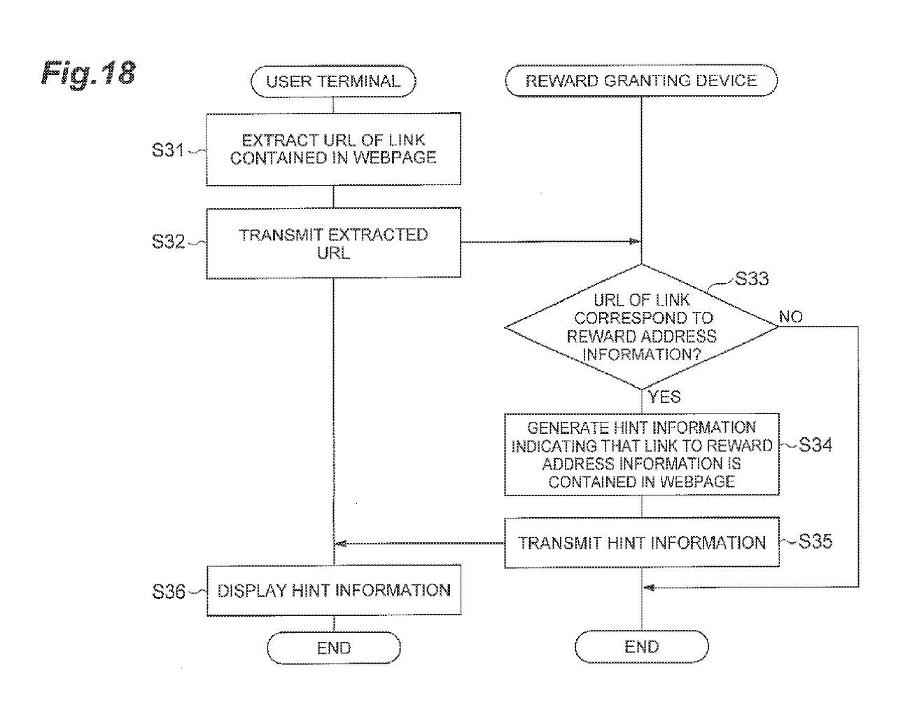

FIG. 18 is a timing chart showing an example of a process for providing the hint information H2 to the user terminal 3A. The link URL transmitting unit 36 of the user terminal 3A extracts the URL that is set to a link contained in the webpage displayed on the user terminal 3A (S31). Next, the link URL transmitting unit 36 transmits the extracted URL as a URL of link to the reward granting device 1A (S32).

When the URL of link is received by the link information receiving unit 17 of the reward granting device 1A, the link information determination unit 18 determines whether the URL of link received by the link information receiving unit 17 corresponds to the reward address information stored in the reward information storage unit D1 (S33). When the URL of link corresponds to the reward address information, the process proceeds to Step S34. On the other hand, when the URL of link does not correspond to the reward address information, the process ends.

In Step S34, the hint information generation unit 16 generates hint information indicating that a link to the reward address information is contained in the webpage displayed on the user terminal 3A (S34). In the following Step S35, the transmitting unit 14 transmits the hint information generated by the hint information generation unit 16 to the user terminal 3A (S35). Then, the hint information is received by the reward-related information receiving unit 35 of the user terminal 3A, and the display unit 33 displays the hint information (S36).

As a result that the hint information is provided to the user terminal 3A as described above, a user can recognize that address information related to a link contained in the webpage displayed on the user terminal 3A is relevant to reward granting, and therefore the user's access to the linked website is encouraged, motivated by the granting of a reward.

Provision of hint information based on a keyword in a webpage indicated by reward address information is described hereinafter with reference back to FIGS. 13 and 14.

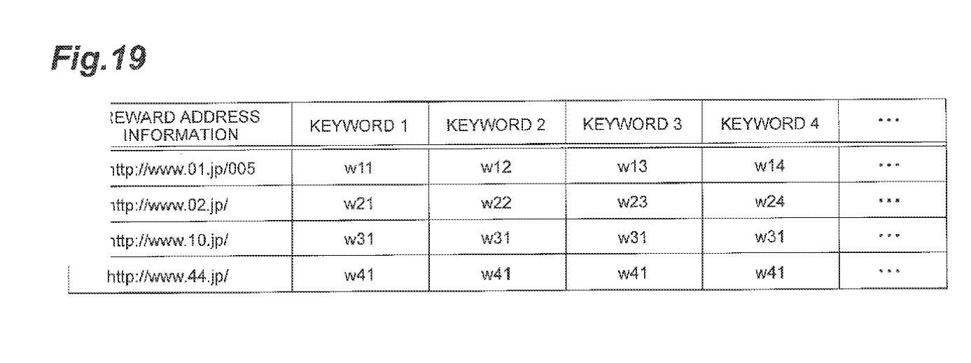

The keyword storage unit D3 is a database that previously stores keywords in websites indicated by reward address information. FIG. 19 is a diagram showing a configuration of the keyword storage unit D3 and an example of data stored therein. As shown in FIG. 19, the keyword storage unit D3 stores keywords in a website indicated by reward address information for each reward address information.

The keyword acquisition unit 19 is a part that extracts a keyword from the keyword storage unit D3. The keyword acquisition unit 19 extracts one or a plurality of keywords according to a predetermined specified rule, for example. The keyword acquisition unit 19 may extract one keyword for one reward address information or extract a keyword in a random manner, for example. Further, the keyword acquisition unit 19 may select reward address information according to the order of priority that is preset to the reward address information stored in the keyword storage unit D3 and extract a keyword associated with the selected reward address information, or extract a keyword associated with the randomly specified reward address information.

The hint information generation unit 16 generates hint information (third hint information) that contains the keyword extracted by the keyword acquisition unit 19. The hint information may be a message that encourages a search by the extracted keyword, for example. Then, the transmitting unit 14 transmits the hint information generated by the hint information generation unit 16 to the user terminal 3A.

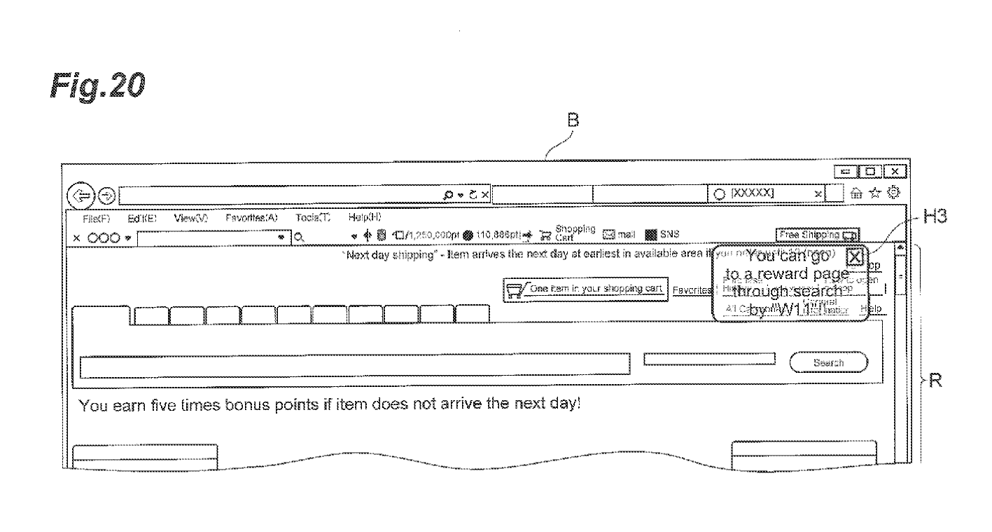

The reward-related information receiving unit 35 of the user terminal 3A receives the hint information transmitted from the reward granting device 1A as the reward-related information. Then, the display unit 33 displays the hint information received by the reward-related information receiving unit 35. FIG. 20 is a diagram showing a display example of the hint information. As shown in FIG. 20, the display unit 33 displays hint information H3 such as a message “You can go to a reward page through search by “W11” !!” superimposed on the webpage, for example.

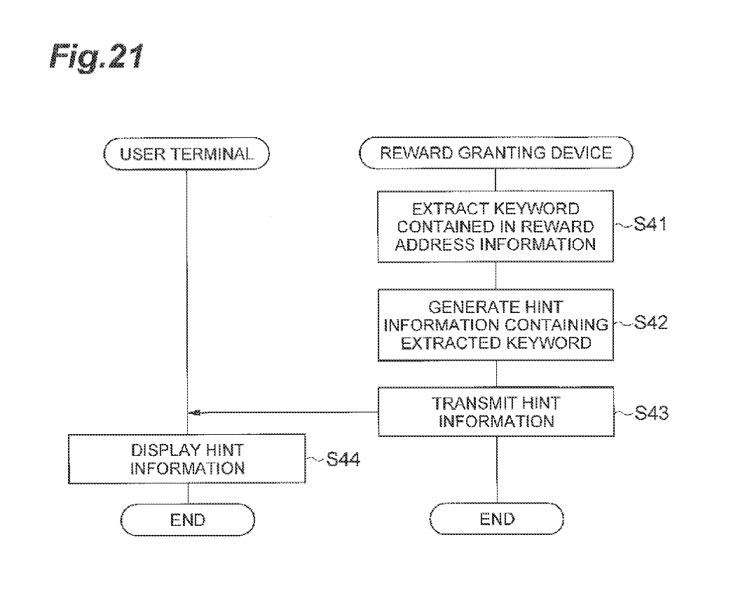

FIG. 21 is a timing chart showing an example of a process for providing the hint information H3 to the user terminal 3A. Note that the process shown in FIG. 21 may be performed in order to provide the hint information to the user terminal 3A when the user terminal 3A accesses a specified website, or may be performed in order to provide the hint information to the user terminal 3A where the reward-related information display program 3P is running at a given time interval or at random timing. First, the keyword acquisition unit 19 extracts a keyword from the keyword storage unit D3 (S41). Next, the hint information generation unit 16 generates hint information that contains the keyword extracted by the keyword acquisition unit 19 (S42).

In the following Step S43, the transmitting unit 14 transmits the hint information generated by the hint information generation unit 16 to the user terminal 3A (S43). Then, the hint information is received by the reward-related information receiving unit 35 of the user terminal 3A, and the display unit 33 displays the hint information (S44).

As a result that the hint information is provided to the user terminal 3A as described above, the keyword contained in the website indicated by the reward address information is recognized by a user. This recognition can be a motivation for searching the website by the keyword. Accordingly, the opportunities that the user views the website obtained as a result of the searching are increased.

Note that the system 100 may have a configuration in which the user terminal 3A transmits a word extracted by morphological analysis from the website viewed in the user terminal 3A to the reward granting device 1A, and, when the word transmitted from the user terminal 3A matches the keyword stored in the keyword storage unit D3, the reward granting device 1A generates hint information that contains the keyword and provides the hint information to the user terminal 3A.

Provision of hint information based on information such as a bookmark or a favorite item registered by a user in a site related to reward granting such as a shopping site, for example, is described hereinafter with reference back to FIGS. 13 and 14. The information such as a bookmark or a favorite item can serve as specifying information that can specify a website. For example, in the case where a shopping site is on the web server W, a user of the user terminal 3A can logs into the shopping site and register a favorite item or the like as a bookmark. In this example, the bookmark registered in this manner is used to provide hint information.

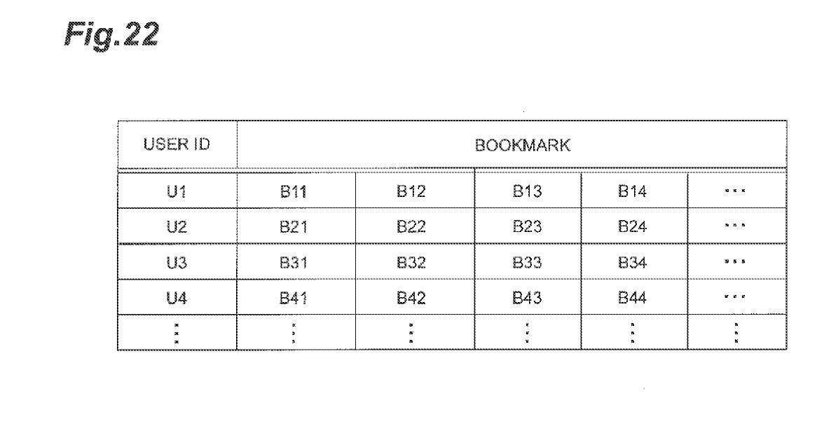

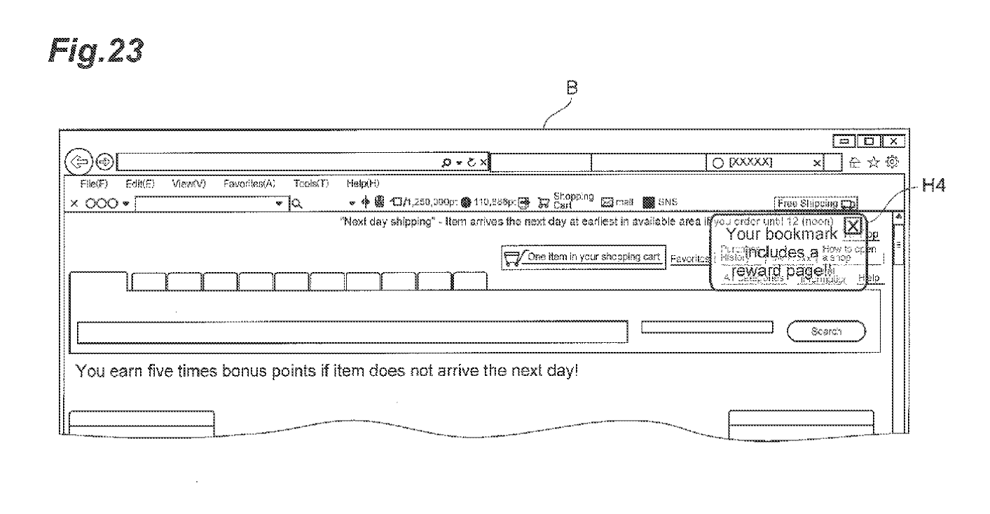

The bookmark storage unit D4 is a database that stores bookmarks registered by users. FIG. 22 is a diagram showing a configuration of the bookmark storage unit D4 and an example of data stored therein. As shown in FIG. 22, the bookmark storage unit D4 stores bookmarks registered by a user for each user ID.

The bookmark determination unit 20 determines whether a bookmark that specifies a website indicated by the reward address information stored in the reward information storage unit D1 is stored in the bookmark storage unit D4. Because bookmarks are data registered in the shopping site or the like on the web server W, the bookmark storage unit D4 according to this embodiment is not necessarily configured in the database D which can be directly accessed by the reward granting device 1A, and it may be configured in a database associated with the web server W in some cases. In such a case, the bookmark determination unit 20 acquires bookmarks registered by users in collaboration with the web server W through the network N. Note that the bookmark storage unit D4 may be configured in the database D, and bookmarks from the web server W may be stored in advance in the bookmark storage unit D4.

When the bookmark determination unit 20 determines that the specifying information that specifies the website indicated by the reward address information is stored in the bookmark storage unit D4, the hint information generation unit 16 generates hint information (fourth hint information) indicating that the bookmark selected by a user contains the bookmark that specifies the website indicated by the reward address information. Then, the transmitting unit 14 transmits the hint information generated by the hint information generation unit 16 to the user terminal 3A.

The reward-related information receiving unit 35 of the user terminal 3A receives the hint information transmitted from the reward granting device 1A as the reward-related information. Then, the display unit 33 displays the hint information received by the reward-related information receiving unit 35. FIG. 23 is a diagram showing a display example of the hint information. As shown in FIG. 23, the display unit 33 displays hint information H4 such as a message “Your bookmark includes a reward page!!” superimposed on the webpage, for example.

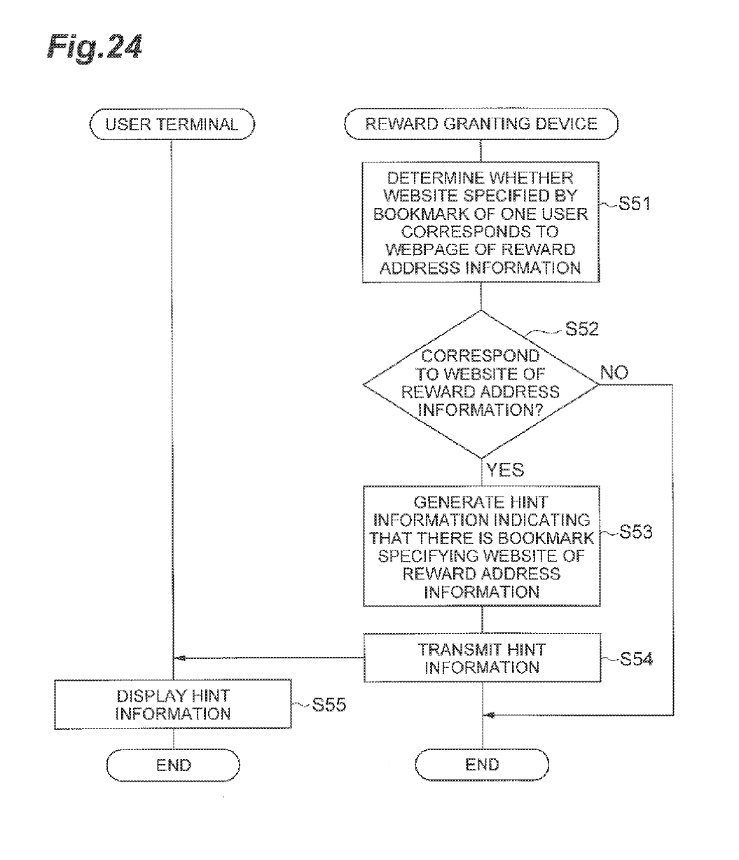

FIG. 24 is a timing chart showing an example of a process for providing the hint information H4 to the user terminal 3A. Note that the process shown in FIG. 24 is performed when a user of the user terminal 3A logs into a specified shopping site on the web server W, at arbitrary timing during login or the like, for example. First, the bookmark determination unit 20 determines whether a website indicated by a bookmark of one user corresponds to the website indicated by the reward address information stored in the reward information storage unit D1 (S51). When it is determined that they correspond, the process proceeds to Step S53. On the other hand, when it is not determined that they correspond, the process ends (S52).

In Step S53, the hint information generation unit 16 generates hint information indicating that the bookmark selected by a user contains the bookmark that specifies the website indicated by the reward address information (S53). In the following Step S54, the transmitting unit 14 transmits the hint information generated by the hint information generation unit 16 to the user terminal 3A (S54). Then, the hint information is received by the reward-related information receiving unit 35 of the user terminal 3A, and the display unit 33 displays the hint information (S55).

As a result that the hint information is provided to the user terminal 3A as described above, it is recognized by a user that the bookmark selected by the user includes the one that specifies the website indicated by the reward address information. The user is thereby encouraged to access the website indicated by the bookmark.

Note that bookmarks registered in a browser running on the user terminal 3A can be used to provide hint information. In this case, the user terminal 3A transmits the bookmark registered in the browser to the reward granting device 1A, and the bookmark determination unit 20 acquires the bookmarks. Further, the bookmark determination unit 20 may access the user terminal 3A and acquire the bookmarks registered in the browser. Then, the bookmark determination unit 20 determines whether the bookmark registered in the browser of the user terminal 3A specifies the website indicated by the reward address information stored in the reward information storage unit D1.

When the bookmark determination unit 20 determines that the bookmark registered in the browser of the user terminal 3A specifies the website indicated by the reward address information, the hint information generation unit 16 generates hint information indicating that the bookmark selected by a user includes the bookmark that specifies the website indicated by the reward address information. Then, the transmitting unit 14 transmits the hint information generated by the hint information generation unit 16 to the user terminal 3A. In this case also, the hint information H4 such as the message shown in FIG. 23, for example, is displayed by the display unit 33 of the user terminal 3A.

Note that the reward granting device 1A may include all of the functional units for generating the first to fourth hint information or may include the functional units for generating one or a plurality of the first to fourth hint information.

Hereinbefore, the present invention has been described in detail with respect to the embodiment thereof. However, the present invention is not limited to the above-described embodiment. Various changes and modifications may be made therein without departing from the scope of the invention.

### INDUSTRIAL APPLICABILITY

According to the embodiment, it is possible to increase the opportunities that a specific website and a website related to the specific website on the Internet are viewed by users.

### REFERENCE SIGNS LIST

1,1A . . . reward granting device, 3,3A . . . user terminal, 11 . . . request acquisition unit, 12 . . . determination unit, 13 . . . reward-related information generation unit, 14 . . . transmitting unit, 15 . . . matching degree determination unit, 16 . . . hint information generation unit, 17 . . . link information receiving unit, 18 . . . link information determination unit, 19 . . . keyword acquisition unit, 20 . . . bookmark determination unit, 31 . . . access request unit, 32 . . . webpage information receiving unit, 33 . . . display unit, 34 . . . address information transmitting unit, 35 . . . reward-related information receiving unit, 36 . . . link URL transmitting unit, D . . . database, D1 . . . reward information storage unit, D2 . . . user attribute storage unit, D3 . . . keyword storage unit, D4 . . . bookmark storage unit, M . . . shop terminal, 1D . . . storage medium, 1P . . . reward granting program, P10 . . . main module, P11 . . . request acquisition module, P12 . . . determination module, P13 . . . reward-related information generation module, P14 . . . transmitting module, R . . . webpage display area, T . . . toolbar display area, W . . . web server

1. (canceled)

2. (canceled)

3. A reward granting device capable of communicating with a user terminal, comprising:
at least one memory operable to store program code;
at least one processor operable to access said memory, read said program code, and operate as instructed by said program code, said program code including;
[an] acquisition code configured to cause at least one of said at least one processors to acquire address information indicating a location of a website on the Internet and contained in an access request to the website from the user terminal;
[a] determination code configured to cause at least one of said at least one processors to determine whether the address information [acquired by the acquisition] is related address information related to reward address information;
[a] transmitting code configured to cause at least one of said at least one processors to transmit hint information to the user terminal when it is determined that the address information is the related address information; and
granting code configured to cause at least one of said at least one processors to grant a reward on condition that an access is made to a specific website indicated by the reward address information, wherein
the determination code determines whether the address information is the related address information by referring to a reward information storage that stores the reward address information in association with information about a description of a reward to be granted to a user,
the hint information indicates that an access can be made to the specific website by an operation on information contained in a website indicated by the related address information and does not contain information specifying a link to the specific website,
the hint information is to be displayed together with the website indicated by the related address information determined to be related to the reward address information.

4. The reward granting device according to claim 3, wherein
the determination code causes at least one of said at least one processors to carry [carries] out a lottery to win or lose based on a specified winning probability set in advance in order to determine whether or not to grant a reward to a user of the user terminal having transmitted the address information corresponding to the reward address information, and
the transmitting code causes at least one of said at least one processors to transmit [transmits] the reward-related information containing a result of the lottery [in the determination].

5. The reward granting device according to claim 4, wherein
the reward information storage stores a plurality of ranks and a description of a reward for each of the ranks as the information about a description of a reward for each of the reward address information, and
the determination code causes at least one of said at least one processors to carry [carries] out a lottery to win or lose on any rank of the plurality of ranks based on a specified winning probability set in advance for each of the ranks.

6. The reward granting device according to claim 4, wherein
in the reward information storage, a reward address information group including a plurality of reward address information associated with one another is set, reference ranks are set for the plurality of reward address information included in the reward address information group, and the number of winners being the number of users to whom a reward is to be granted is set for each of the reward address information, and
the determination code causes at least one of said at least one processors to carry [carries] out a lottery by referring to the reward address information for which a highest reference rank is set among the reward address information where the number of users to whom a reward is granted does not reach the number of winners out of the plurality of reward address information included in the reward address information group as the valid reward address information.

7. The reward granting device according to claim 4, wherein
the determination code causes at least one of said at least one processors to refer [refers] to a user attribute storage that stores attribute information of users and uses a fact that a user of the user terminal has a specified attribute as a condition for the lottery.

8. The reward granting device according to claim 3, further comprising:
[a] matching degree determination code configured to cause at least one of said at least one processors to determine a degree of matching of the address information acquired [by the acquisition unit] with the reward address information stored in the reward information storage; and
[a] first hint information generation code configured to cause at least one of said at least one processors to generate first hint information indicating the degree of matching determined [by the matching degree determination], wherein
the transmitting code causes at least one of said at least one processors to transmit [transmits] the first hint information [generated by the first hint information generation] to the user terminal.

9. The reward granting device according to claim 3, to said program code further comprising:
[a] link information receiving code configured to cause at least one of said at least one processors to receive address information of a link contained in a webpage displayed on the user terminal;
[a] link information determination code configured to cause at least one of said at least one processors to determine whether the address information received [by the link information receiving] corresponds to the reward address information stored in the reward information storage; and
[a] second hint information generation code configured to cause at least one of said at least one processors to generate second hint information indicating that a link to the reward address information is contained in the webpage displayed on the user terminal when it is determined [by the link information determination] that the address information corresponds to the reward address information, wherein
the transmitting code causes at least one of said at least one processors to transmit [transmits] the second hint information generated [by the second hint information generation] to the user terminal.

10. The reward granting device according to claim 3, said program code further comprising:
[a] third hint information generation code configured to cause at least one of said at least one processors to refer to a keyword storage that stores keywords contained in a website indicated by the reward address information and generate third hint information containing one or more keywords, wherein
the transmitting code causes at least one of said at least one processors to transmit [transmits] the third hint information [generated by the third hint information generation] to the user terminal.

11. The reward granting device according to claim 3, said program code further comprising:
[a] specifying information determination code configured to cause at least one of said at least one processors to acquire specifying information for specifying a website designated by a user from a specifying information storage that stores the specifying information for each user or from the user terminal of the user, and determines whether the specifying information designated by the user corresponds to specifying information specifying a website indicated by the reward address information stored in the reward information storage; and
[a] fourth hint information generation code configured to cause at least one of said at least one processors to generate fourth hint information indicating that the specifying information specifying the website indicated by the reward address information is included in the specifying information designated by the user when it is determined [by the specifying information determination] that the specifying information designated by the user corresponds to the specifying information specifying the website indicated by the reward address information, wherein
the transmitting code causes at least one of said at least one processors to transmit[transmits] the fourth hint information [generated by the fourth hint information generation] to the user terminal.

12. The reward granting device according to claim 3, wherein
the transmitting code causes at least one of said at least one processors to transmit[transmits] the reward-related information together with instruction information for displaying the reward-related information superimposed on a webpage without altering source information for displaying the webpage on the user terminal.

13. The reward granting device according to claim 3, wherein
the transmitting code causes at least one of said at least one processors to transmit[transmits] the reward-related information together with instruction information for displaying the reward-related information outside a display area of a webpage without altering source information for displaying the webpage on the user terminal.

14. A reward granting method in a reward granting device capable of communicating with a user terminal, comprising:
[an acquisition step of] acquiring address information indicating a location of a website on the Internet and contained in an access request to the website from the user terminal;
[a determination step of] determining whether the address information acquired [in the acquisition step] is related address information related to reward address information;
[a transmitting step of] transmitting hint information to the user terminal when it is determined that the address information is the related address information;
[a granting step of] granting a reward on condition that an access is made to a specific website indicated by the reward address information; and
determining whether the address information is the related address information by referring to a reward information storage that stores the reward address information in association with information about a description of a reward to be granted to a user, wherein
the hint information indicates that an access can be made to the specific website by an operation on information contained in a website indicated by the related address information and does not contain information specifying a link to the specific website, and
the hint information is to be displayed together with the website indicated by the related address information determined to be related to the reward address information.

15. A non-transitory computer-readable recording medium storing a reward granting program causing a computer to function as a reward granting device capable of communicating with a user terminal, the program causing the computer to [implement]:
[an acquisition function to] acquire address information indicating a location of a website on the Internet and contained in an access request to the website from the user terminal;
[a determination function to] determine whether the address information acquired by the acquisition function is related address information related to reward address information;
[a transmitting function to] transmit hint information to the user terminal when it is determined that the address information is the related address information:
grant a reward on condition that an access is made to a specific website indicated by the reward address information; and
determine whether the address information is the related address information by referring to a reward information storage that stores the reward address information in association with information about a description of a reward to be granted to a user, wherein
the hint information indicates that an access can be made to the specific website by an operation on information contained in a website indicated by the related address information and does not contain information specifying a link to the specific website, and
the hint information is to be displayed together with the website indicated by the related address information determined to be related to the reward address information.

16. (canceled)

17. (canceled)

18. (canceled)

19. (canceled)

20. The reward granting device according to claim 5, wherein
in the reward information storage, a reward address information group including a plurality of reward address information associated with one another is set, reference ranks are set for the plurality of reward address information included in the reward address information group, and the number of winners being the number of users to whom a reward is to be granted is set for each of the reward address information, and
the determination code causes at least one of said at least one processors to carry out a lottery by referring to the reward address information for which a highest reference rank is set among the reward address information where the number of users to whom a reward is granted does not reach the number of winners out of the plurality of reward address information included in the reward address information group as the valid reward address information.

21. The reward granting device according to claim 4, further comprising:
matching degree determination code configured to cause at least one of said at least one processors to determine a degree of matching of the address information acquired with the reward address information stored in the reward information storage; and
first hint information generation code configured to cause at least one of said at least one processors to generate first hint information indicating the degree of matching determined, wherein
the transmitting code causes at least one of said at least one processors to transmits the first hint information to the user terminal.

22. The reward granting device according to claim 4, further comprising:
link information receiving code configured to cause at least one of said at least one processors to receive address information of a link contained in a webpage displayed on the user terminal;
link information determination code configured to cause at least one of said at least one processors to determine whether the address information received corresponds to the reward address information stored in the reward information storage; and
second hint information generation code configured to cause at least one of said at least one processors to generate second hint information indicating that a link to the reward address information is contained in the webpage displayed on the user terminal when it is determined that the address information corresponds to the reward address information, wherein
the transmitting code causes at least one of said at least one processors to transmit the second hint information to the user terminal.

23. The reward granting device according to claim 4, further comprising:
third hint information generation code configured to cause at least one of said at least one processors to refer to a keyword storage that stores keywords contained in a website indicated by the reward address information and generate third hint information containing one or more keywords, wherein
the transmitting code causes at least one of said at least one processors to transmit the third hint information to the user terminal.

24. The reward granting device according to claim 4, further comprising:
specifying information determination code configured to cause at least one of said at least one processors to acquire specifying information for specifying a website designated by a user from a specifying information storage that stores the specifying information for each user or from the user terminal of the user, and determines whether the specifying information designated by the user corresponds to specifying information specifying a website indicated by the reward address information stored in the reward information storage; and
fourth hint information generation code configured to cause at least one of said at least one processors to generate fourth hint information indicating that the specifying information specifying the website indicated by the reward address information is included in the specifying information designated by the user when it is determined that the specifying information designated by the user corresponds to the specifying information specifying the website indicated by the reward address information, wherein
the transmitting code causes at least one of said at least one processors to transmit the fourth hint information to the user terminal.

25. The reward granting device according to claim 4, wherein
the transmitting code causes at least one of said at least one processors to transmit the reward-related information together with instruction information for displaying the reward-related information superimposed on a webpage without altering source information for displaying the webpage on the user terminal.

26. The reward granting device according to claim 4, wherein
the transmitting code causes at least one of said at least one processors to transmit the reward-related information together with instruction information for displaying the reward-related information outside a display area of a webpage without altering source information for displaying the webpage on the user terminal.
